(19) United States
(12) Patent Application Publication
(10) Pub. No.: US 2024/0401924 A1
(43) Pub. Date: Dec. 5, 2024

(54) Vehicle Measurement Apparatus

(71) Applicant: Autel Intelligent Technology Corp., Ltd., Shenzhen (CN)

(72) Inventors: Zihao ZHENG, Shenzhen (CN); Biwang LAI, Shenzhen (CN); Wenhui LUO, Shenzhen (CN)

(73) Assignee: Autel Intelligent Technology Corp., Ltd., Shenzhen, GD (CN)

(21) Appl. No.: 18/699,593

(22) PCT Filed: Sep. 1, 2022
(86) PCT No.: PCT/CN2022/116501

§ 371 Date: Apr. 9, 2024

(30) Foreign Application Priority Data
Oct. 10, 2021 (CN) 202111178514.2

(51) Int. Cl. G01B 3/30; G01B 5/00

(52) U.S. Cl. CPC G01B 3/303; G01B 5/0025

(57) ABSTRACT

A vehicle measurement apparatus, includes a base module, a column module, and a crossbeam module, the column module being mounted on the base module, and the crossbeam module comprising a crossbeam, an adjustment mechanism and a fine-adjustment mechanism, wherein one end of the fine-adjustment mechanism is mounted on the column module, and the other end of the fine-adjustment mechanism is mounted on the adjustment mechanism; the crossbeam is mounted on the adjustment mechanism; the adjustment mechanism is configured to adjust the position of the crossbeam relative to the column module; and the fine-adjustment mechanism is configured to adjust the position of the adjustment mechanism relative to the column module. With the above structure, during the adjustment process, a user can adjust the position of the crossbeam only by means of the fine-adjustment mechanism and the adjustment mechanism.

This application claims priority to Chinese Patent Application No. 202111178514.2, entitled “Vehicle Measurement Apparatus”, filed to the China Patent Office, on Oct. 10, 2021, the entire contents of which are incorporated herein by reference.

### PRIOR ART

The present application relates to the field of automotive calibration, and in particular to a vehicle measurement apparatus.

### BACKGROUND OF THE INVENTION

As an indispensable vehicle in people's lives, automobiles have been used in many fields, and their safety performance requirements are constantly improving. Typically, after a period of use, the vehicle will need to be sent to a service facility for maintenance, such as, calibrating a wheel by four wheel positioning; or the ADAS is calibrated to ensure that sensors such as cameras or radars inside the vehicle accurately obtain road condition information.

Currently, on-the-market vehicle measurement apparatuses, such as ADAS (Advanced Driver Assistant Systems) calibration devices, are required to ensure that the measurement device is flat and symmetrical with the vehicle body when the ADAS calibration is performed on an automobile, usually by adjusting the position of the base of the vehicle measurement apparatus relative to the ground. This requires a worker to frequently bend over during the adjustment, thereby causing inconvenience.

### SUMMARY OF THE INVENTION

In order to solve the above technical problem, embodiments of the present invention provide a vehicle measurement apparatus which is convenient for use.

The embodiments of the present invention solve the technical problem thereof by using the following technical solutions.

A vehicle measurement apparatus comprises:
a base module;
a column module disposed in a vertical direction and mounted on the base module;
a crossbeam module comprising a crossbeam and an adjustment unit, wherein the crossbeam is mounted on one side of the adjustment unit; the other side of the adjustment unit is mounted to the column module; the adjustment unit is configured for adjusting a pitch angle and a roll angle formed by displacement of the crossbeam relative to the column module, wherein the pitch angle is an angle at which the crossbeam rotates about a first axis in a horizontal direction, and the roll angle is an angle at which the crossbeam rotates about a second axis perpendicular to the first axis and the vertical direction.

Optionally, the adjustment unit includes an adjustment mechanism and a fine-adjustment mechanism; wherein one end of the fine-adjustment mechanism is mounted to the column module, and the other end of the fine-adjustment mechanism is mounted to the adjustment mechanism; the crossbeam is mounted to the adjustment mechanism configured for adjusting a position of the crossbeam relative to the column module; and the fine-adjustment mechanism is configured for adjusting a pitch angle and a roll angle between the crossbeam and the column module.

Optionally, the fine-adjustment mechanism comprises a first fine-adjustment plate, a second fine-adjustment plate, and a first fine-adjustment assembly; wherein one end of the first fine-adjustment plate is rotatably connected to the adjustment mechanism; the other end of the first fine-adjustment plate is connected to one end of the second fine-adjustment plate; the other end of the second fine-adjustment plate is connected to the column module; and the first fine-adjustment assembly is mounted to the first fine-adjustment plate configured for rotating the adjustment mechanism relative to the first fine-adjustment plate.

Optionally, the first fine-adjustment assembly comprises a rotational bearing, a first fine-adjustment screw rod, a drive block, and a first mounting block; the rotational bearing is mounted to the first fine-adjustment plate; the rotational bearing is connected to the adjustment mechanism; the first mounting block is mounted to the first fine-adjustment plate; the first mounting block is provided with a first threaded hole; the first fine-adjustment screw rod is threadedly connected to the first mounting block via the first threaded hole; one end of the drive block is connected to the adjustment mechanism, and the other end of the drive block extends at least to meet the central axis of the first fine-adjustment screw rod; and
when the first fine-adjustment screw rod is gradually screwed and the first fine-adjustment screw rod gradually pushes the other end of the drive block to move, one end of the drive block will drive the adjustment mechanism to rotate in a first pre-set direction about the first axis, the first axis being the central axis of the rotational bearing.

Optionally, the first fine-adjustment assembly further comprises a second mounting block mounted to the other end of the drive block; the first fine-adjustment screw rod passes through the first mounting block and then is connected to the second mounting block; and
when the first fine-adjustment screw rod is screwed in a reverse direction and the first fine-adjustment screw rod gradually moves in a direction away from the first fine-adjustment plate, the drive block drives the adjustment mechanism to rotate about the central axis of the rotational bearing in a second pre-set direction, the first pre-set direction being opposite to the second pre-set direction.

Optionally, the first mounting block is rotatable relative to the first fine-adjustment plate; the second mounting block is rotatable relative to the drive block; a first gap is provided between the first mounting block and a side wall of the first fine-adjustment plate; and a second gap is provided between the second mounting block and the drive block.

Optionally, the first fine-adjustment assembly further comprises a bearing seat mounted to the second mounting block and a bearing member embedded in the bearing seat, the bearing member being sleeved on the first fine-adjustment screw rod.

Optionally, the fine-adjustment mechanism further comprises a second fine-adjustment assembly mounted to the first fine-adjustment plate and the second fine-adjustment plate; and the second fine-adjustment assembly is configured for adjusting an angle between the first fine-adjustment plate and the second fine-adjustment plate.

Optionally, the second fine-adjustment assembly includes a power lever, a first connection block, a second connection block, a connection rod, and a hinge; one end of the hinge is connected to the first fine-adjustment plate, and the other end of the hinge is connected to the second fine-adjustment plate; the power lever is rotatably mounted to the first fine-adjustment plate; the first connection block is connected to the power lever; one end of the connection rod is connected to the first connection block, and the other end of the connection rod is connected to the second connection block; and the second connection block is connected to the second fine-adjustment plate, wherein the first connection block is provided with an internal threaded hole, the surface of the power lever has a thread; the first connection block is threadedly connected with the power lever; and
when the power lever rotates and drives the first connection block along the axial direction of the power lever, the connection rod swings therewith to drive the first fine-adjustment plate to unfold or close relative to the second fine-adjustment plate.

Optionally, the second fine-adjustment assembly includes a guide slipper and a guide bar; the first fine-adjustment plate includes a mounting bar; the guide bar is mounted to the mounting bar; the guide slipper is slidably mounted to the guide bar; and the guide slipper is connected to the first connection block.

Optionally, the second fine-adjustment assembly further comprises a second fine-adjustment screw rod, a first bevel gear, a second bevel gear and a limit bearing; one end of the second fine-adjustment screw rod is connected to the first bevel gear, and the other end of the second fine-adjustment screw rod is exposed outside the first fine-adjustment plate; the second bevel gear is mounted on one end of the power lever; the second bevel gear meshes with the first bevel gear; the other end of the power lever is sleeved with the limit bearing; the limit bearing is fixedly mounted on the first fine-adjustment plate; and
when the first bevel gear is rotated by screwing the second fine-adjustment screw rod, the second bevel gear drives the power lever to rotate, so as to adjust an angle between the first fine-adjustment plate and the second fine-adjustment plate.

Optionally, the adjustment mechanism is configured for adjusting a rotation angle of the crossbeam relative to the column module, the rotation angle being an angle between the first axis and the second axis.

Optionally, the adjustment mechanism includes a first connection plate connected to the crossbeam, a second connection plate connected to the fine-adjustment mechanism, a supporting plate connected to the second connection plate and located between the first connection plate and the second connection plate, and an adjustment assembly mounted to the first connection plate, the second connection plate and the supporting plate and configured for adjusting a rotation angle between the crossbeam relative to the column module.

Optionally, the adjustment assembly includes a rotating shaft rotatably mounted to the supporting plate and connected to the first connection plate, a first drive rod, an elastic member, and a mounting rod; the first drive rod is connected to one end of the first connection plate; the first drive rod is connected to the supporting plate; the mounting rod is mounted to the other end of the first connection plate; the mounting rod faces towards the supporting plate; the elastic member is sleeved on the mounting rod; and
when the first drive rod is driven to move one end of the first connection plate in a direction away from the supporting plate, under the action of the rotating shaft, the other end of the first connection plate moves towards the supporting plate and presses the elastic member, so that the first connection plate rotates the crossbeam about the central axis of the column module.

Optionally, the adjustment assembly further comprises a third mounting block rotatably mounted to the first connection plate, the first drive rod being connected to the third mounting block, wherein a third gap is provided between the third mounting block and an end face of the first connection plate facing towards the second connection plate.

Optionally, the adjustment mechanism further comprises a fourth mounting block rotatably mounted to the supporting plate, the fourth mounting block being provided with an inner threaded hole; and the first drive rod is threadedly connected to the fourth mounting block.

Optionally, the adjustment assembly further comprises a receiving member, one end of which has an opening; the supporting plate is provided with a communication hole; the receiving member is mounted to the supporting plate; the opening communicates with the communication hole; the elastic member is partially received in the receiving member; one end of the elastic member abuts against a bottom of the receiving member; and the other end of the elastic member abuts against the first connection plate, wherein a diameter of the communication hole is greater than an axial diameter of the mounting rod.

Optionally, the adjustment assembly further comprises a second screw rod, a rack, a gear, and a sliding bar; the sliding bar is mounted to the supporting plate, and can slide in a pre-set direction relative to the supporting plate; the second connection plate is connected to the sliding bar; the rack is mounted to the supporting plate; the supporting plate is provided with an avoidance hole; the gear is mounted to one end of the second screw rod; the other end of the second screw rod passes through the avoidance hole; the gear meshes with the rack; and
when the second screw is screwed, the gear drives the rack to move the supporting plate in the pre-set direction.

Optionally, the adjustment assembly further comprises a guide slipper mounted to the supporting plate, the guide slipper being mounted in cooperation with the sliding bar.

Optionally, the adjustment assembly further comprises a level bead mounted to the supporting plate and configured for detecting whether the crossbeam is in a horizontal state.

Optionally, the crossbeam includes a left crossbeam portion, a right crossbeam portion, and a connecting portion supported by the column module; one end of the connecting portion is pivotably connected to the left crossbeam portion, the other end of the connecting portion being pivotably connected to the right crossbeam portion.

Optionally, the crossbeam module further comprises a hinge assembly including a first fixed seat, a second fixed seat, and a rotational shaft; the first fixed seat is hinged to the second fixed seat via the rotational shaft; the first fixed seat and the second fixed seat are both mounted to the crossbeam; and the hinge assembly is configured for hinging the left crossbeam portion and the connecting portion, and the right crossbeam portion and the connecting portion.

Optionally, the crossbeam module further comprises a locking assembly mounted to the hinge assembly; and the locking assembly is configured for locking the first fixed seat with the second fixed seat, so that the crossbeam is in an unfold state.

Optionally, the base module includes a base, at least three universal wheels each mounted to the base; and multiple ones of the universal wheels are disposed in a polygonal shape at an end of the base away from the column module; and the foot brake assembly is mounted to the base.

Optionally, the foot brake assembly includes a locking pedal, an elastic pedal, a storage cylinder, a stop block, and a connecting pin; the storage cylinder is mounted to the base; the storage cylinder is provided with a guide groove; the stop block is partially received in the storage cylinder; the connecting pin is connected to the elastic pedal and penetrates the storage cylinder and the stop block; the locking pedal is hinged to the storage cylinder and the elastic pedal;
when the locking pedal gradually rotates in a direction close to the stop block, the stop block gradually slides along the guide groove and extends out of the storage cylinder, the elastic pedal rotates around the central axis of the connecting pin in a direction away from the stop block; and the elastic pedal is pressed to reset both the locking pedal and the stop block.

Optionally, the column module includes a fixed column, a mobile column assembly and a drive assembly; the fixed column is fixedly connected to the base module; the mobile column assembly is movably mounted to the fixed column; wherein the mobile column assembly is connected with the drive assembly; the crossbeam module is supported by the mobile column assembly; and the drive assembly is configured for driving the mobile column assembly up and down relative to the fixed column to move the crossbeam module.

Optionally, the vehicle measurement apparatus further comprises a laser mounted to the mobile column assembly; the base module is provided with a through hole located directly below an emitting end of the laser used for measuring a height of the crossbeam module from the ground.

Optionally, the vehicle measurement apparatus further comprises a camera assembly mounted to the crossbeam module and configured for acquiring a vehicle-related image.

Advantageous effects of embodiments of the present invention. Embodiments of the present invention provide a vehicle measurement apparatus, comprising a base module, a column module, and a crossbeam module, the column module being mounted on the base module, and the crossbeam module comprising a crossbeam, an adjustment mechanism and a fine-adjustment mechanism, wherein one end of the fine-adjustment mechanism is mounted on the column module, and the other end of the fine-adjustment mechanism is mounted on the adjustment mechanism; the crossbeam is mounted on the adjustment mechanism; the adjustment mechanism is configured for adjusting the position of the crossbeam relative to the column module; and the fine-adjustment mechanism is configured for adjusting the position of the adjustment mechanism relative to the column module. With the above structure, during the adjustment process, a user can adjust the position of the crossbeam only by means of the fine-adjustment mechanism and the adjustment mechanism, such that the position of the crossbeam can be adjusted without frequently bending down to adjust the base module, and the operation is convenient.

### BRIEF DESCRIPTION OF DRAWINGS

One or more embodiments are exemplified by pictures in the accompanying drawings to which they correspond, which do not constitute a qualification to the embodiments. Elements in the drawings having the same reference numerals are represented as similar elements. The figures are not to scale unless otherwise specified.

FIG. 1 is a structurally schematic view of a vehicle measurement apparatus in an embodiment of the invention;

FIG. 2 is a schematic view from another angle of FIG. 1;

FIG. 3 is an exploded view of the structure of FIG. 1;

FIG. 4 is a schematic view of a base module of FIG. 3;

FIG. 5 is a schematic view of a column module of FIG. 1;

FIG. 6 is an exploded view of the structure of FIG. 5;

FIG. 7 is an exploded view of a portion of the structure of FIG. 6;

FIG. 8 is an enlarged view of a portion A in FIG. 7;

FIG. 9 is an exploded view of a mobile column assembly of FIG. 6;

FIG. 10 is a further exploded view of FIG. 9;

FIG. 11 is an enlarged view of a portion B in FIG. 9;

FIG. 12 is a schematic view of another angle of FIG. 7;

FIG. 13 is a structurally schematic view of a crossbeam module and a camera assembly of FIG. 1;

FIG. 14 is a schematic view of another angle of FIG. 13;

FIG. 15 is a schematic view of a portion of the structure of FIG. 13;

FIG. 16 is a block diagram of a hinge assembly and a locking assembly of FIG. 13;

FIG. 17 is a schematic view of another view of the locking assembly of FIG. 16;

FIG. 18 is a structurally schematic view of another embodiment of the hinge assembly and locking assembly of FIG. 13;

FIG. 19 is an exploded view of the structure of FIG. 18;

FIG. 20 is an exploded view of the structure of the locking assembly of FIG. 18;

FIG. 21 is a schematic view of a second hinge of FIG. 18 not flush with a first hinge:

FIG. 22 is another state diagram of FIG. 21;

FIG. 23 is a schematic view of a primary slide assembly of FIG. 13;

FIG. 24 is a schematic view of an auxiliary slide assembly of FIG. 13;

FIG. 25 is a schematic view of another angle of FIG. 24;

FIG. 26 is a schematic view of a suspension rod assembly of FIG. 13;

FIG. 27 is a structurally schematic view of a main control and an adjustment mechanism of FIG. 1;

FIG. 28 is an exploded view of a portion of the structure of FIG. 27;

FIG. 29 is an exploded view of the adjustment mechanism of FIG. 27;

FIG. 30 is a schematic view of a portion of the structure of FIG. 27;

FIG. 31 is a schematic view of a portion of the structure of FIG. 27;

FIG. 32 is an exploded view of a portion of the structure of FIG. 27;

FIG. 33 is a schematic view of a display assembly of FIG. 1;

FIG. 34 is a schematic view of a portion of the structure of FIG. 32;

FIG. 35 is a structurally schematic view of a vehicle measurement apparatus according to another embodiment of the invention;

FIG. 36 is a schematic view of a base module of FIG. 35;

FIG. 37 is an enlarged view of a portion C in FIG. 36;

FIG. 38 is an assembled schematic view of an adjustment mechanism, a fine adjustment structure, and a main control of FIG. 35;

FIG. 39 is a schematic view from another angle of FIG. 38;

FIG. 40 is an exploded view of a portion of the structure of FIG. 39;

FIG. 41 is an exploded view of a portion of the structure of FIG. 40;

FIG. 42 is an exploded view of a portion of the structure of FIG. 40;

FIG. 43 is a schematic view of a first fine-adjustment plate of FIG. 42;

FIG. 44 is a schematic view of another angle of FIG. 42;

FIG. 45 is an exploded view of a portion of the structure of FIG. 40;

FIG. 46 is a side view of a portion of the structure of FIG. 39;

FIG. 47 is a rear view of a portion of the structure of FIG. 39;

FIG. 48 is a perspective view of a portion of the structure of FIG. 39.

### DETAILED DESCRIPTION OF THE INVENTION

In order to facilitate understanding of the invention, the invention is described in more detail in combination with the attached drawings and specific embodiments. It should be noted that when an element is stated to be “fixed” to another element, it may be directly on another component, or one or more intervening elements may be present therebetween. When a element is referred to as being “connected” to another element, it may be directly connected to another element, or one or more intervening elements may be present therebetween. In the description, it should be understood that the directional or positional relationships indicated by the terms “up”, “down”, “front”, “inner”, “outer”, “left”, “right”, “vertical”, “horizontal” and the like are based on the directional or positional relationships shown in the drawings. It is merely for the purpose of describing the present application and simplifying the description, and is not intended to indicate or imply that a particular orientation, configuration and operation of the referenced device or element is required and should not be construed as limiting the scope of the present invention. Furthermore, the terms “first”, “second” and the like are used solely for descriptive purposes and are not to be construed as indicating or implying relative importance.

Unless defined otherwise, all technical and scientific terms used in the specification have the same meaning as commonly understood by one of ordinary skill in the art to which this invention belongs. The terminology used in the specification of the invention herein is for the purpose of describing particular embodiments only and is not intended to be limiting of the invention. As used herein, the term “and/or” in the specification includes any and all combinations of one or more of the associated listed items.

Furthermore, the technical features involved in the various embodiments of the present invention described below may be combined with each other as long as they do not conflict with each other.

### Embodiment 1

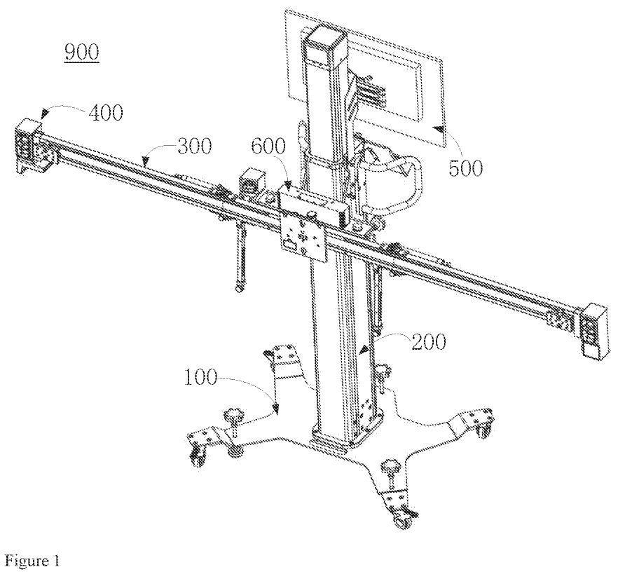

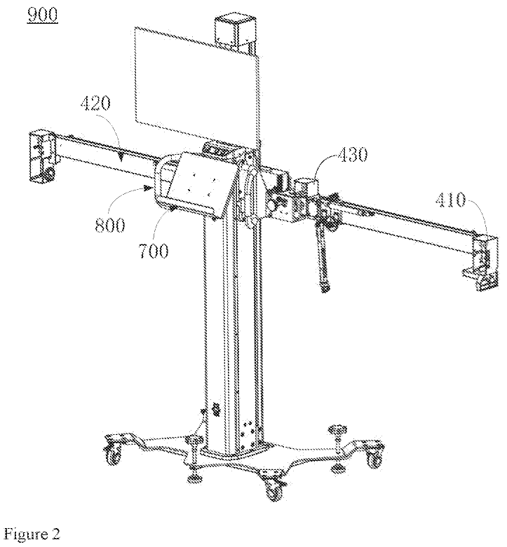

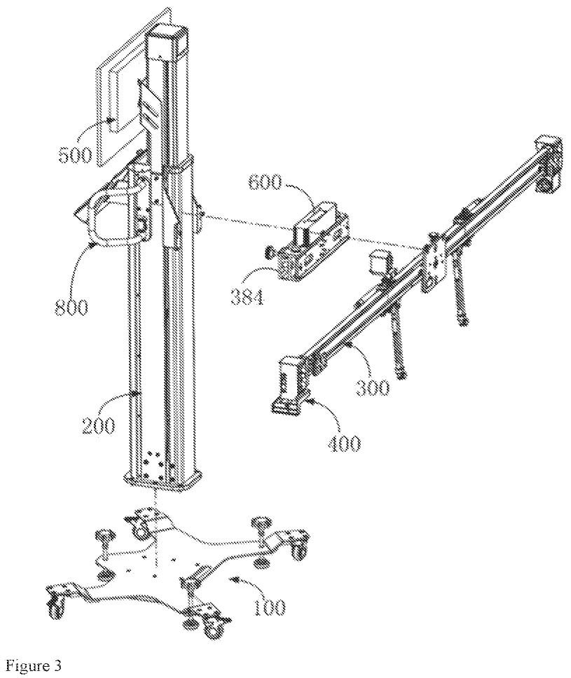

As shown in FIGS. 1-3, an embodiment of the present invention provides a vehicle measurement apparatus 900 including a base module 100, a column module 200 mounted to the base module 100, a crossbeam module 300 mounted to the column module 200, and a camera assembly 400 mounted to the crossbeam module 300. The column module 200 is used to support the crossbeam module 300 and may be used to adjust a height of the crossbeam module 300 from the ground. The crossbeam module 300 may be used to support calibration elements. The camera assembly 400 is used to capture wheel information of a vehicle. In this manner, a user may capture wheel information of the vehicle by the camera assembly 400 to calibrate the wheels of the vehicle for four-wheel positioning. Also, the calibration elements are supported by the crossbeam module 300 to calibrate sensors on the vehicle.

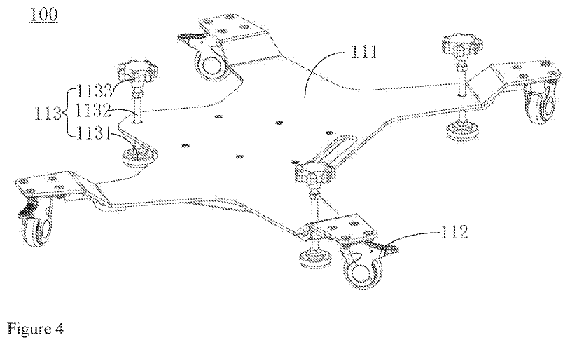

Referring to FIG. 4, in some embodiments, the base module 100 includes a base 111, a plurality of universal wheels 112, and a plurality of foot cups 113. The plurality of universal wheels 112, and the plurality of foot cups 113 are all mounted to the base 111. The universal wheel 112 may facilitate movement of the vehicle measurement apparatus 900. The foot cup 113 may be used to stabilize the base module 100 at a particular location. The foot cup 113 may also be used to adjust the height of the base module 100. The base 111 is used to mount the column module 200. In this embodiment, the base 111 has four outwardly extending mounting portions (not shown). The number of the universal wheels 112 is four. One of the universal wheels 112 is mounted correspondingly to each mounting portion. The number of the foot cups 113 is three. Three of the foot cups are triangularly distributed at three positions of the base 111. By adjusting the foot cups, the angle of the column module relative to the ground may be adjusted, and then the pitch angle of a measurement module may be adjusted. Here, the foot cup 113 includes a support block 1131, a link rod 1132 and a cap portion 1133. The outer surface of the link rod 1132 has threads. One end of the link rod 1132 is threadedly connected to the cap portion 1133, the other end of the link rod is threadedly connected to the support block 1131. The support block 1131 is used for abutting against the ground. In this way, the distance between the base 111 and the ground may be adjusted by screwing the nut portion 1133, thereby adjusting the overall position and the overall posture of the vehicle measurement apparatus 900.

As shown in FIGS. 5-7, in some embodiments, the column module 200 includes a fixed column 210 connected to the base 111, a mobile column assembly 220 movably mounted to the fixed column 210 and connected to the drive assembly 230, and a drive assembly 230 disposable within the fixed column. In some implementations, the drive assembly 230 is used to drive only the mobile column assembly 220 up or down relative to the fixed column 210. The crossbeam module 300 moves up or down simultaneously with the mobile column assembly 220. In this manner, the crossbeam module 300 may be controlled to be moved up or down by the drive assembly 230 so that the crossbeam module 300 will be adjusted to different ground heights. Thus, the vehicle measurement apparatus 900 may be adapted to more scenarios. For example, vehicles of different vehicle models may be calibrated using the same vehicle measurement apparatus 900. In this application, “up” or “down” refers to vertical movement relative to a reference. The vertical direction is substantially the same as the length of the column module, for example, the vertical movement of the mobile column assembly 220 relative to the fixed column 210, the vertical movement of the crossbeam module 300 relative to the mobile column assembly 220, etc. In other implementations, while the drive assembly is used to drive the mobile column assembly 220 up or down relative to the fixed column 210, the drive assembly 230 is also used to drive the crossbeam module 300 up or down relative to the mobile column assembly 220. That is, the mobile column assembly 220 is not synchronized with the movement of the crossbeam module 300. The mobile column assembly 220 and the crossbeam module 300 may move in the same direction or in opposite directions. The speed of movement of the mobile column assembly 220 and the speed of movement of the crossbeam module 300 may be the same or different. The drive mechanism in the drive assembly for driving the mobile column assembly 220 relative to the fixed column 210 may be associated with the drive mechanism for driving the crossbeam module 300 relative to the mobile column assembly 220, or the two drive mechanisms may be independent of each other. This paper mainly introduces some implementations in which the drive assembly drives the mobile column assembly 210 in the same direction as the movement of the crossbeam module 300, and the movement speed of the crossbeam module 300 is faster than that of the mobile column assembly 210. Other drive methods of the drive assembly shall also be included in the scope of this application. By allowing the mobile column assembly 220 to move relative to the fixed column 210 and the crossbeam module 300 to move relative to the mobile column assembly 210, the volume of the column module can be reduced while ensuring the range of movement of the crossbeam module and extending the range of use, which may meet the requirements of both the measurement of wheel positioning functions at different heights and the calibration functions of auxiliary systems at different heights.

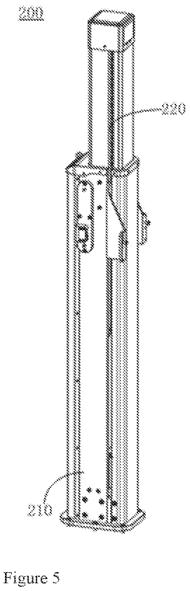

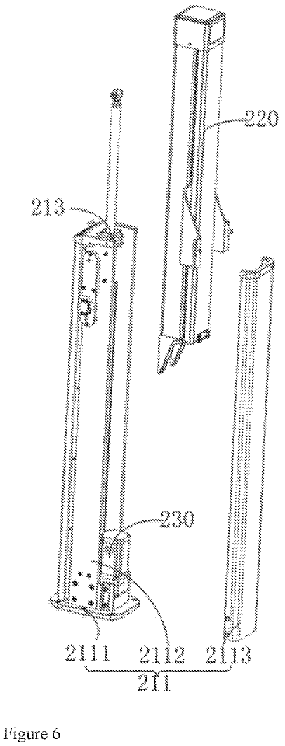

With reference to FIGS. 5 and 6, the fixed column 210 includes a column housing 211, a fixed support 212, a limit seat 213 and a sliding assembly 214. The fixed support 212, the limit seat 213 and the sliding assembly 214 are all mounted in the column housing 211, and the fixed support 212 and the limit seat 213 are respectively located at two ends of the column housing 211. The fixed support 212 is used for connecting with the drive assembly 230. The limit seat 213 is used for limiting the mobile column assembly 220. The sliding assembly 214 is used for connecting with the mobile column assembly 220.

Here, the column housing 211 includes a foundation seat 2111, a first column housing 2112, and a second column housing 2113. The foundation seat 2111 is used for being fixedly mounted to a base 11l in a base module 100. The fixed support 212 is disposed on the foundation seat 2111. The first column housing 2112 is mounted on the foundation seat 2111 and forms a receiving cavity (not shown). The second column housing 2113 is detachably connected to the first column housing 2112 to enclose the receiving cavity. When the second column housing 2113 is mounted on the foundation seat 2111, a gap exists between the second column housing 2113 and the first column housing 2111. Specifically, each of the first column housing 2111 and the second column housing 2113 includes a main plate and two side plates which are arranged on both sides of the main plate and are oppositely arranged so that the cross section of the first column housing 2111 and the second column housing 2113 is generally concave. The main plates of the first column housing 2111 and the second column housing 2113 are opposite. The side plates of the first column housing 2111 and the second column housing 2113 located on the same side are not connected and coupled, but have a gap therebetween. Likewise, a gap also exists between the side plates of the first column housing 2111 and the second column housing 2113 on the other side. The gaps between the side plates on both sides are in a substantially vertical direction, which is the same as the movement direction of the crossbeam module 300. By means of the gap formed by the closure of the first column housing 2112 and the second column housing 2113, a free sliding movement of the crossbeam module on the fixed column is achieved, i.e., it is ensured that an elevating plate for mounting the crossbeam module described below can move relative to the fixed column. The fixed support 212 is detachably mounted to the foundation seat 2111 and received in the receiving cavity. The limit seat 213 is mounted to an end of the first column housing 2112 away from the foundation seat 2111. The sliding assembly 214 is slidably mounted to the first column housing 2112. In this embodiment, the first column housing 2112 is provided with two symmetrically disposed fasteners 2114 adjacent to the foundation seat 2111.

The sliding assembly 214 includes a guide rail 2141 mounted to an inner wall of the first column housing 2112 and arranged along an axial direction (length direction) of the first column housing 2112, and a sliding block 2142 mounted in cooperation with the guide rail 2141, the sliding block 2142 being connected to the mobile column assembly 220.

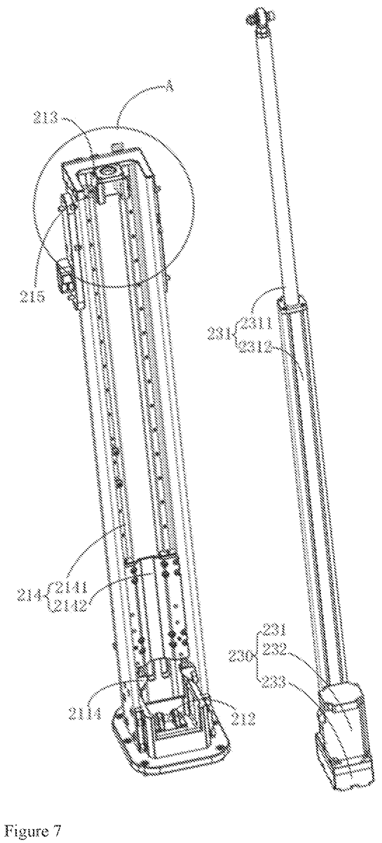

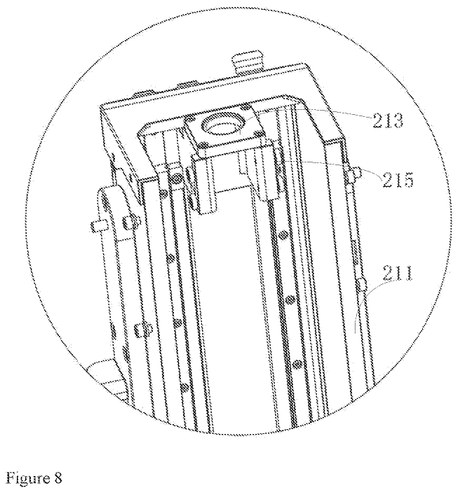

Referring to FIGS. 7 and 8, in some embodiments, the fixed column 210 is further provided with a plurality of rollers 215. The plurality of rollers 215 are movably mounted on side ends of the limit seat 213 and partially extend out of the edge of the limit seat 213 and abut against the mobile column assembly 220. The plurality of rollers 215 serve to reduce frictional resistance between the mobile column assembly 220 and the fixed column 210.

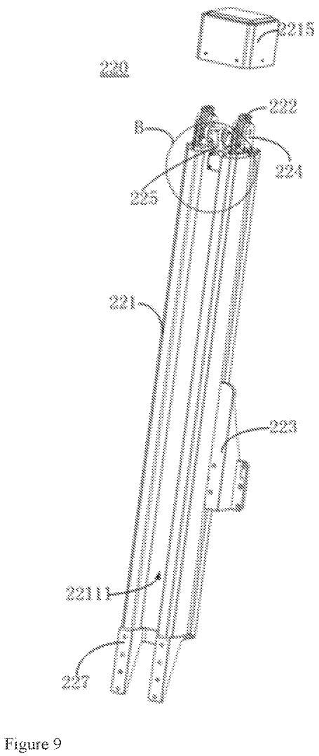

As shown in FIG. 9, the mobile column assembly 220 includes a column body 221, a pull member 222, and an elevating plate 223. The pull member 222 is mounted to the column body 221. One end of the pull member 222 is connected to the first column housing 2112, and the other end of the pull member 222 is connected to the elevating plate 223, the elevating plate 223 being connected to the crossbeam module 300. In this embodiment, the pull member 222 is a chain. One end of the chain is fixedly connected to the fastener 2114 on the first column housing 2112, and the other end of the chain passes through the top of the column body 221 and is connected to the elevating plate 223. It should be understood that the pull member 222 may be other structures in addition to the chain, for example, a rope or a wire rope, etc. as long as the moving up and down of the elevating plate 223 may be performed.

In this manner, as the drive assembly 230 drives the mobile column assembly 220 up or down relative to the fixed column 210, the elevating plate 223 will move relative to the column body 221 by the pull member to move the crossbeam module 300 up or down. Here, the crossbeam module 300 is pulled by the pull member 222 so as to move twice as much as the column body 221, i.e., the moving speed of the crossbeam module 300 by the pull member 222 is twice as fast as the moving speed of the column body 221. That is, it can be seen that the movement distance of the crossbeam module 300 is twice the movement distance of the column body 221 in the same time. Further, the range of movement of the crossbeam is increased. It is possible to adjust the crossbeam module to almost any height of the column module. For example, when moving the column up to the highest height, the height of the entire column module may be 2.5 m, in which case the height adjustment range of the crossbeam module may be (0.3 m, 2.1 m). Thereby, it is ensured that the height of the crossbeam module can be adapted both for the wheel positioning measurement function and for the calibration function of the auxiliary driving system. Here, the pull member may pull the crossbeam module 300 to move in the same direction as the mobile column assembly 220.

As shown in FIG. 10, the column body 221 includes a first column housing 2211, a second column housing 2212, a top plate 2213 and a bottom plate 2214. The top plate 2213 is connected to one ends of the first column housing 2211 and the second column housing 2212. The bottom plate 2214 is connected to the other ends of the first column housing 2211 and the second column housing 2212. The pull member 222 and the elevating plate 223 are both mounted between the first column housing 2211 and the second column housing 2212. The top plate 2213 is provided with a plurality of openings (not shown). The pull member 222 is connected to the fixed column 210 and the elevating plate 223 via the openings. Here, the first column housing 2211 is provided with an avoidance groove 22111. The avoidance groove and the elevating plate 223 are respectively located at two opposite side ends of the first column housing 2211. The column body 221 is movably received in the fixed column 210. That is to say, the mobile column assembly can be sleeved in the fixed column 210. The avoidance groove is used for avoiding the drive assembly 230 during the moving up or down of the column body 221.

The elevating plate 223 includes a main body plate 2231 connected to the pull member 222, and a connection plate 2232 connected to both ends of the main body plate 2231, the connection plate 2232 being connected to the crossbeam module 300.

Further, the mobile column assembly 220 further includes a rotating member 224 mounted to the top plate 2213 of the column body 221. The pull member 222 partially wound around the rotating member 224 for reducing friction between the pull member 222 and the column body 221. In this embodiment, the rotating member 224 is a sprocket that cooperates with the chain to more stably raise and lower the mobile column assembly 220 relative to the fixed column 210. Of course, the rotating member 224 may have another structure, and is not limited to the sprocket, so long as it can reduce the friction between the pull member 222 and the column body 221, for example, a movable pulley.

In some embodiments, in order to prevent the rotating member 224 from being directly affected by external dust or the like, the column body 221 further includes a top cover 2215 which is disposed over the top plate 2213 so that the rotating member 224 is not exposed to the outside. At the same time, the top cover cooperates with the first column housing 2211 and the second column housing 2212 to shield the pull member 222 from direct action from the outside.

In some embodiments, the column body 221 is provided with a guide structure (not shown) through which the main body plate 2231 is directionally movable. The guide structure may be a slide block. In this case, the column body 221 is provided with a slide groove. The slide block may slide directionally in the slide groove. The slide block is connected to the main body plate 2231. The guide structure may be another structure, for example, a combination of a guide bar fixedly installed at the inner wall of the column body 221 and a guide block connected to the main body plate 2231.

With reference to FIGS. 9 and 11, in some embodiments, the mobile column assembly 220 further includes connection supports 225 mounted to the top plate 2213 and distributed along the axial direction of the column body 221 and away from the fixed column 210. The connection support 225 is used to be connected with the drive assembly 230. In this embodiment, the connection support 225 has a foundation block 2251 and two symmetrically arranged connecting arm blocks 2252. The foundation block is connected to the column body 221. The two connecting arm blocks 2252 are respectively connected to two ends of the foundation block 2251. A through hole (not shown) is formed on each of the connecting arm blocks 2252.

In some embodiments, the mobile column assembly 220 further includes a drag reduction member 226 mounted to the second column housing 2212, the drag reduction member 226 abutting against an inner wall of the fixed column 210. In this embodiment, the drag reduction member 226 includes a plurality of wheels 2261 and a mounting block 2262 for mounting the plurality of wheels 2261, the mounting block 2262 being fixedly mounted to the second column housing 2212. When the mobile column assembly 220 moves up or down relative to the fixed column 210, the plurality of wheels 2261 will have rolling friction with the column housing 211, preventing the mobile column assembly 220 and the fixed column 210 from interfering with the moving up or down of the elevating plate 223 due to excessive frictional resistance.

In some embodiments, the mobile column assembly 220 further includes a guide connector 227, as shown in FIG. 9, mounted to the column body 221. The guide connector 227 is connected to the sliding block 2142 of the fixed column 210. Thus, driven by the drive assembly 230, the column body 221 moves only along the axial direction of the fixed column 210 under the combined action of the guide connector 227 and the sliding block 2142.

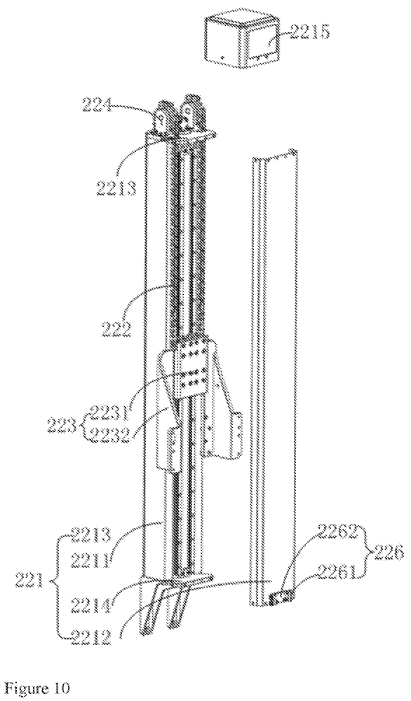

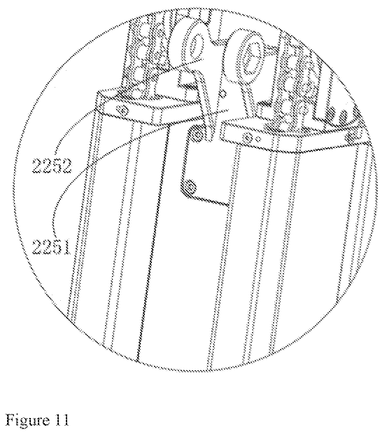

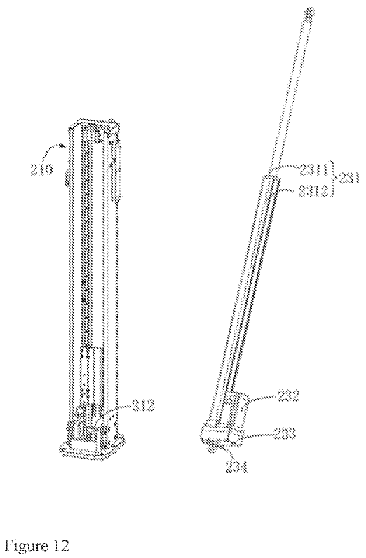

As shown in FIG. 12, the drive assembly 230 includes a pusher 231 having a push rod 2311 and a main body 2312. The push rod 2311 is movably mounted inside the main body 2312, namely, the push rod 2311 may be telescopic relative to the main body 2312. An end of the push rod 2311 away from the main body 2312 passes through the limit seat 213 and is connected to the mobile column assembly 220. When the push rod 2311 is gradually extended out of the main body 2312, the push rod 2311 will gradually push the mobile column assembly 220 to extend out of the fixed column 210. When the push rod 2311 is reversely retracted into the main body 2312, the push rod 2311 will bring the mobile column assembly 220 to retract into the fixed column 210. It should be understood that the pusher 231 may be a cylinder or a hydraulic cylinder, or other structures. The push rod 2311 is a push rod of the cylinder or hydraulic cylinder and the main body 2312 is a cylinder of the cylinder or hydraulic cylinder.

Further, the drive assembly 230 further includes a drive motor 232 and a conversion box 233. The drive motor 232 has an output shaft connected to the conversion box 233. The main body 2312 is connected to the conversion box 233. The conversion box 233 is connected to the fixed column 210. When the output shaft of the drive motor 232 rotates, the conversion box 233 drives the push rod 2311 to push the mobile column assembly 220 to extend out of or retract to the fixed column 210. As can be appreciated, the conversion box 233 is used for converting the rotation of the output shaft of the drive motor 232 into the linear movement of the push rod 2311. In this embodiment, the conversion box 233 is a gear box, a plurality of gears for transmission are disposed inside the gear box. The push rod 2311 is a lead screw. The output shaft of the drive motor 232 is connected to one gear of the gear box, and the other gear of the gear box meshes with the lead screw.

The drive assembly 230 further includes a hinged plate 234 mounted at an end of the conversion box 233 facing towards the fixed support 212, with which the hinged plate 234 is hinged. It will be appreciated that the hinged plate 234 is hinged to the fixed support 212 such that the hinged plate 234 causes the conversion box 233 to rotate slightly relative to the fixed support 212, allowing the pusher 231 to be adaptively and flexibly adjusted during use. Also, the central axis of the pusher 231 will remain parallel relative to the central axis of the fixed column 210, under the restriction of the limit seat 213, to avoid jamming when the pusher 231 pushes the mobile column assembly 220.

In some embodiments, the vehicle measurement apparatus 900 further includes a control system mounted to the fixed column 210 for controlling the drive assembly 230 to drive the mobile column assembly 220 up or down relative to the fixed column 210. In this embodiment, the control system includes a power source and a switch button. The power source is connected to the motor driver and the switch button, respectively. The motor driver is used for driving and controlling the operation of the drive motor 232. The switch button is used for controlling the mobile column assembly 220 to move up or down relative to the fixed column 210. In some embodiments, the control system further includes an emergency control button for instructing the control system to power down or for instructing the control system to stop outputting control commands to avoid a hazard in case of an emergency. In some embodiments, the control system further includes an elevating button for receiving a user operation and transmitting a user lift command to the motor driver to control the elevating operation of the driver to drive the push rod. The elevating button and the emergency control button may be disposed on the column housing of the fixed column, and the height thereof may be set so as to facilitate user operation and improve user experience.

With the above-mentioned structure, under the action of the pusher 231, the mobile column assembly 220 may extend out of or retract into the fixed column 210. If the overall height of the column body 221 approaches the overall height of the fixed column, the overall minimum height of the column module 200 is the height of the fixed column. The maximum height approaches the sum of the axial lengths of the fixed column 210 and the column body 221, i.e., approximately twice the height of the fixed column. Of course, the maximum height above ground that the elevating plate 223 may ascend approximates the maximum height of the column module 200. The minimum height above ground that the elevating plate 223 may descend is the height above ground that the column housing 221 approaches the foundation seat 2111 when the column housing 221 is fully retracted into the fixed column 210. Accordingly, a user may adjust the height of the column module 200 as needed so that the crossbeam module 300 has different height from the ground. Thus, the column module 200 may simultaneously satisfy the height required for four-wheel positioning and the Advanced Driving Assistance System (ADAS).

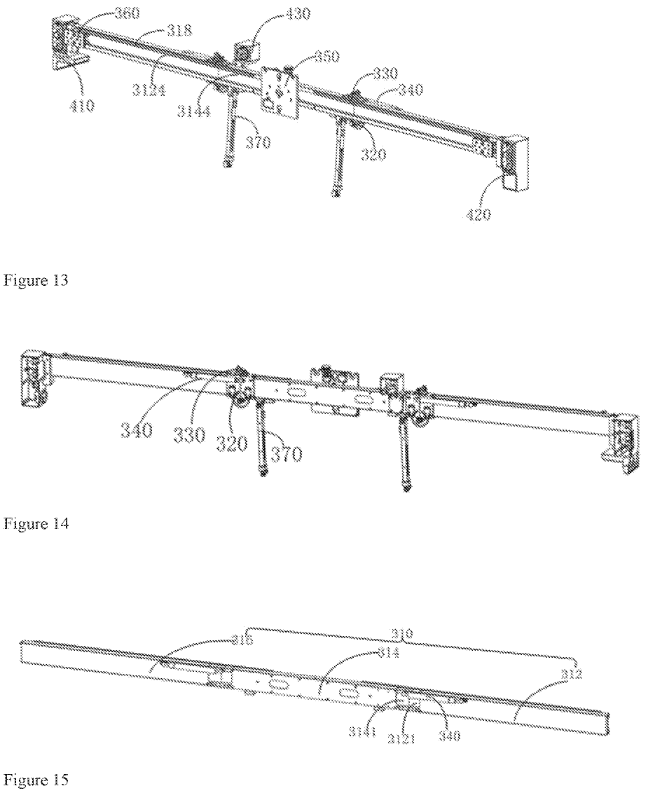

As shown in FIGS. 13-15, the crossbeam module 300 includes a crossbeam 310 including a left crossbeam portion 312, a connecting portion 314, and a right crossbeam portion 316. The connecting portion 314 has one end pivotably connected to the left crossbeam portion 312, and another end pivotably connected to the right crossbeam portion 312. The connecting portion 314 is supported by the elevating plate 223. As such, the crossbeam 310 will have an unfolded state and a folded state. When the crossbeam 310 is in the unfolded state, the left crossbeam portion 312 and the right crossbeam portion 316 will both rotate to be at a horizontal line with the connecting portion 314. Conversely, when the crossbeam 310 is folded, the left crossbeam portion 312 and the right crossbeam portion 316 will both have an angle with the connecting portion 314. The included angle is greater than 0 degree and less than or equal to 90 degrees It will be appreciated that the calibration element may be mounted directly on the crossbeam 310, for example by means of hooks or magnets hanging directly on the crossbeam 310. The crossbeam 310 may be used to mount the calibration element, whether in an unfold or folded state. In the unfold state of the crossbeam 310, the calibration elements may be mounted at various locations on the crossbeam 310 to meet calibration requirements. The crossbeam 310, in its folded state, may be used to mount the calibration element together with the left crossbeam portion 312 and the right crossbeam portion 316.

Thus, when the vehicle measurement apparatus 900 is not needed, the space occupied by the vehicle measurement apparatus 900 may be reduced by rotating both the left crossbeam portion 312 and the right crossbeam portion 316 relative to the connecting portion 314 so that the crossbeam 310 is in a folded state. Under the influence of gravity, both the left crossbeam portion 312 and the right crossbeam portion 316 will naturally sag. The angle between them and the connecting portion 314 approaches 90 degrees which minimizes the space occupied by the vehicle measurement apparatus 900.

It should be understood that a hinge structure, which may be a combination of a pin shaft and a pin hole, is disposed between the left crossbeam portion 316 and the connecting portion 314. The hinge structure may be a combination of a pin shaft and a pin hole. In particular, the left crossbeam portion 312 is provided with a first pin hole, and the connecting portion 314 is provided with a second pin hole. The pin shaft is inserted through the first pin hole and the pin hole, so that the left crossbeam portion 312 and the connecting portion 314 are pivotable. Also, the pin hole and the pin shaft may be hinged between the right crossbeam portion 316 and the connecting portion 314. Of course, the hinge structure may be other structures as long as the left crossbeam portion 312 and the connecting portion 314 are pivotable and the right crossbeam portion 316 and the connecting portion 314 are pivotable.

As shown in FIGS. 13-14, in some embodiments, the left crossbeam portion 312 is hingedly connected to the connecting portion 314 and the right crossbeam portion 316 is hingedly connected to the connecting portion 314 using a hinge assembly. That is, the crossbeam module 300 includes hinge assemblies 320. One group of the hinge assemblies 320 is mounted between the left crossbeam portion 312 and the connecting portion 314, and another group of the hinge assemblies 320 is mounted between the right crossbeam portion 316 and the connecting portion 314.

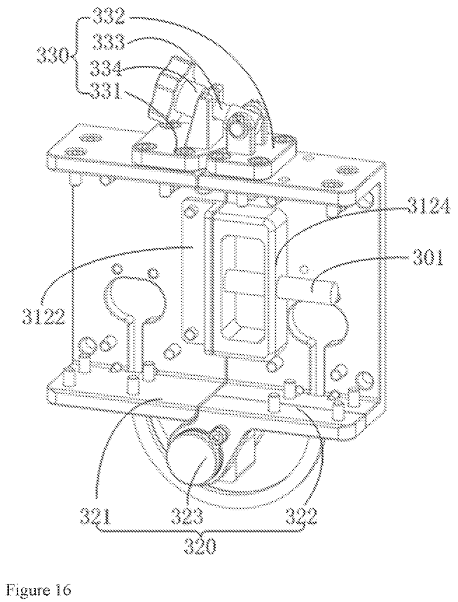

As shown in FIG. 16, the hinge assembly 320 includes a first fixed seat 321, a second fixed seat 322, and a rotational shaft 323 by which the first fixed seat 321 is hinged to the second fixed seat 322 such that the first fixed seat 321 and the second fixed seat 322 rotate with each other by the rotational shaft 323. In the embodiment, the first fixed seat 321 is mounted to the left crossbeam portion 312, the second fixed seat 322 is mounted to the connecting portion 314, and the rotational shaft 323 is located at an end of the crossbeam 310 facing towards the base module 100. Here, the shape of the first fixed seat 321 and the second fixed seat 322 is approximately a semi-frame shape. The first fixed seat 321 and the second fixed seat 322 with the semi-frame shape may quickly cover the crossbeam 310 so as to achieve quick mounting. In order to accurately position the mounting positions of the first fixed seat 321 and the second fixed seat 322, the first fixed seat 321 is provided with a plurality of first positioning studs (not shown). The second fixed seat 322 is provided with a plurality of second positioning studs (not shown). The left crossbeam portion 312 is provided with a plurality of first positioning holes. The right crossbeam portion 316 is provided with a plurality of second positioning holes. Each of the first positioning studs is correspondingly inserted into one of the first positioning holes, and each of the second positioning studs is correspondingly inserted into one of the second positioning holes, so as to realize the quick mounting of the hinge assembly to the crossbeam 310.

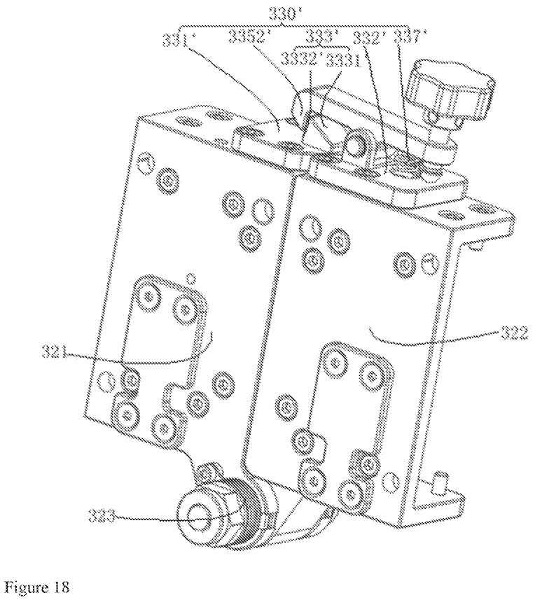

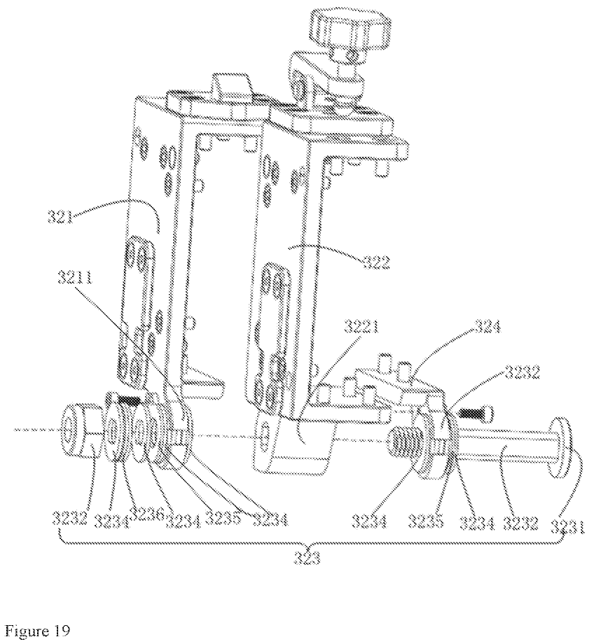

As shown in FIGS. 18-19, in some embodiments, the first fixed seat 321 is provided with a first connecting sleeve 3211. The second fixed seat 322 is provided with a second connecting sleeve 3221. The first connecting sleeve 3211 and the second connecting sleeve 3221 are connected by the damping rotational shaft 323 such that the first fixed seat 321 and the second fixed seat 322 may rotate relative to each other.

In some embodiments, the damping rotational shaft 323 includes a first rotational shaft 3232 provided with a fixed end 3231 and a locking nut 3233. The first connecting sleeve 3211 and the second connecting sleeve 3221 are both sleeved on the first rotational shaft 3221. The locking nut 3233 is in threaded connection with an end of the first rotational shaft 3232. In the embodiment, the second connecting sleeve 3221 is interposed between the first connecting sleeve 3211 and the fixed end 3231 of the first rotating shaft.

First spacers 3234 are disposed between the fixed end 3231 of the first rotational shaft and the second connecting sleeve 3221, between the first connecting sleeve 3211 and the second connecting sleeve 3221 and between the locking nut 3233 and the first connecting sleeve 3211. Here, the first spacer 3234 is used for spacing and protecting the mounting surfaces of the first connecting sleeve 3211 and the second connecting sleeve 3221.

In some embodiments, second washers 3235 are disposed between the locking nut 3233 and the first spacer 3234 and between the fixed end 3231 of the first rotational shaft and the first spacer 3234. The second spacer 3235 is fixed to the first connecting sleeve 3211. The second spacer 3535 is used for positioning a part of the first spacer 3234 so as to prevent the first spacer 3234 from moving axially.

A third spacer 3236 is disposed between the first connecting sleeve 3211 and the locking nut 3233. Specifically, the third spacer 3236 is disposed between the locking nut 3233 and the second spacer 3235. The third spacer 3236 is used for providing a pre-pressing elastic force to ensure that the locking nut 3233 does not cause damping failure of the damping rotational shaft due to loosening during long-term rotation work of the damping rotational shaft.

In some embodiments, the first spacer 3234 is also disposed between the locking nut 3233 and the third spacer 3236 and between the third spacer 3236 and the second spacer 3235.

In some embodiments, strip-shaped holes are disposed in the middle of the first spacer 3234, the second spacer 3235 and the third spacer 3236. The first spacer 3234, the second spacer 3235 and the third spacer 3236 are all positioned on the first rotational shaft 3232 through their own strip-shaped holes.

In some embodiments, the damping rotational shaft 323 is a metal damping rotational shaft structure. The first shaft 3232, the locking nut 3233, the first spacer 3234, the second spacer 3235 and the third spacer 3236 are all metal structures.

In some embodiments, the first spacer 3234 is a friction damping washer. The second washer 3235 is a positioning washer. The third washer 3236 is a bowl-shaped resilient washer.

In some embodiments, to further enhance the damping of the damping rotational shaft 323, the hinge assembly 320 further includes an adjustment plate 324. One end of the adjustment plate 324 is fixed to the first fixed seat 321, and the other end of the adjustment plate 324 includes a third connecting sleeve 3241. The third connecting sleeve 3241 is sleeved on the first shaft 3232. The third connecting sleeve 3241 is disposed between the fixed end 3231 of the first shaft and the second connecting sleeve 3221.

Note that the first spacer 3234 and the second spacer 3235 located between the fixed end 3231 of the first rotational shaft and the second connecting sleeve 3221 are both disposed between the third connecting sleeve 3241 and the fixed end 3231 of the first rotational shaft. The second spacer 3235 is fixed to the third connecting sleeve 3241.

It will be appreciated that to protect the mounting surface of the third connecting sleeve 3241, a first spacer 3234 is disposed between the third connecting sleeve 3241 and the second connecting sleeve 3221.

The damping rotational shaft 323 is disposed so that the first fixed seat 321 may be rotated relative to the second fixed seat 322 by an external force.

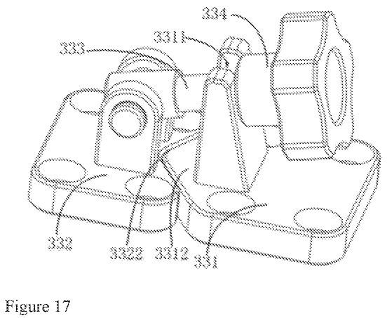

As shown in FIG. 17, in some embodiments, the crossbeam module 300 further includes a locking assembly 330 mounted to the hinge assembly 320 for locking the first fixed seat 321 with the second fixed seat 322 to place the crossbeam 310 in an unfold state. Specifically, the locking assembly 330 includes a first fixed block 331, a second fixed block 332, a rotating rod 333 and a clamping member 334. The first fixed block 331 is mounted to the first fixed seat 321. The second fixed block 332 is mounted to the second fixed seat 322. One end of the rotating rod 333 is rotatably mounted to the second fixed block 332, and the other end of the rotating rod 333 is mounted to the clamping member 334. Here, the first fixed block 331 is provided with a notch 3311 for inserting the rotating rod 333. When the rotating rod 333 is rotated to be fitted into the notch 3311, the clamping member 334 abuts against an edge of the notch 3311 so that the first fixed block 331 and the second fixed block 332 are in the same horizontal plane to lock the first fixed seat 321 and the second fixed seat 322.

Further, in order to enable the first fixed block 331 and the second fixed block 332 to be accurately butted, while ensuring that the left crossbeam portion 312 and the connecting portion 314 are accurately spliced, the first fixed block 331 is provided with a convex portion 3312, the second fixed block 332 is provided with a concave portion 3322. The convex portion 3312 and the concave portion 3322 cooperate. In the present embodiment, the convex portion 3312 has a V-shape, and the concave portion 3322 has a V-shaped groove.

When the convex portion 3312 and the concave portion 3322 are oppositely inserted, the first fixed seat 321 has been moved to a position cooperating with the second fixed seat 322. The first fixed seat 321 has been rotated to an extreme position. At this time, the rotating rod 333 is rotated to be inserted into the notch 3311, so that the clamping block 334 abuts against the first fixed block 321, thereby locking the left crossbeam portion 312 and the connecting portion 314. Likewise, the right crossbeam portion 316 and the connecting portion 314 are also locked using the locking assembly.

In other embodiments, the locking assembly 330 described above may has the following construction.

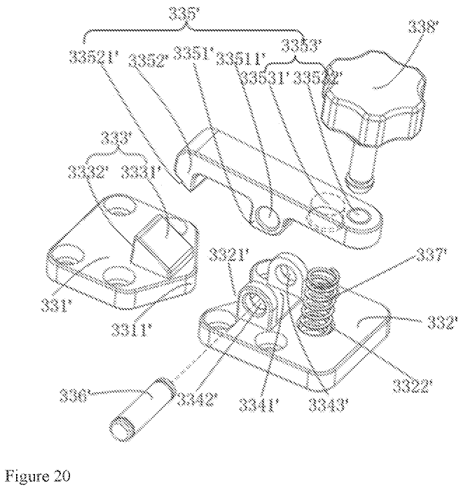

As shown in FIGS. 18-20, the locking assembly 330 includes a first fixed block 331′ mounted to the first fixed seat 321, a second fixed block 332′ mounted to the second fixed seat 322′, a locking block 333′ fixed to the first fixed block 331′, a rotating body 335′ rotatably mounted to the second fixed block 332′, and an resilient member 337. The locking block 333′ is mounted on the first fixed seat 321′ The rotating body 335′ is rotatably mounted on the second fixed seat 322′. One end of the rotating body 335′ is used for engaging (clamping or disengaging) with the locking block 333′, and the other end of the rotating body 335′ is connected with the resilient member 337′. The resilient member 337 is disposed between the second fixed seat 322′ and the other end of the rotating body 335′. The resilient member 337′ is used for providing a restoring force to clamp the rotating body 335′ with the locking block 333′. The second fixed seat 322′ may be locked and unlocked in the above manner.

In the embodiment of the present application, the desired position refers to the position of the second fixed seat 322′ when the second fixed seat 322′ is flush with the first fixed seat 321′.

It is understood that locking the second fixed seat 322′ means limiting the rotation of the second fixed seat 322′ relative to the first fixed seat 321′. Unlocking the second fixed seat 322′ means that the second fixed seat 322′ is rotatable relative to the first fixed seat 321.

Specifically, the second fixed block 332′ is provided with a rotating seat 334′. The rotating seat 334′ is provided with a mounting space 3341′. Two ends of the mounting space 3341′ are respectively provided with a first mounting hole 3342′ and a second mounting hole 3343′. A lower part 3351′ of the rotating body 335′ is placed in the mounting space 3341′. The lower part 3351′ of the rotating body 335′ is provided with a third mounting hole 33511′. The second rotational shaft 336′ passes through the first mounting hole 3342′, the third mounting hole 33511′ and the second mounting hole 3343′ in sequence, so that the rotating body 335′ may rotate relative to the second fixed seat 322.

As can be appreciated, since the lower part 3351′ of the rotating body 335′ is rotatable relative to the rotating seat 334′ in the mounting space 3341′. The lower part 3351′ of the rotating body has a circular arc surface.

In some embodiments, the locking block 333′ includes a first inclined surface 3331′ and a second inclined surface 3332′. A first end of the rotating body 335′ has a hook 3352′. A second end 3353′ of the rotating body 335′ is used for connecting the resilient member 337′. The first inclined surface 3331′ acts on the hook 3352′ for pushing the hook 3352′ to deform the resilient member 337′ when the first fixed seat 321′ approaches the second fixed seat 322′. The second inclined surface 3332′ is used for clamping with the second inclined surface 3332′ under the restoring force of the resilient member 337.

It will be appreciated that in order to ensure the implementability of the solution, the hook 3352′ is disengaged from the first inclined surface 3331′ when the rotating body 335′ is not subjected to an external force and the second fixed seat 322′ is flush with the first fixed seat 321′.

Note that the lower part 3351′ of the rotating body 335′ is located between the first end of the rotating body 335′ and the second end of the rotating body.

For convenience of description, the embodiment of the present application uses the horizontal plane on which the first block 331′ is located as an x-direction and a direction perpendicular to the x-direction as a y-direction.

In some embodiments, the first inclined surface 3331′ includes an angle of 30 degrees to the x-direction.

In some embodiments, the second inclined surface 3332′ includes an angle in the range of 0-5 degrees in the y-direction.

In some embodiments, to make it easier for the first inclined surface 3331′ to push against the hook 3352′, the hook 3352′ includes a third inclined surface 33521′ for contacting the first inclined surface 3331′.

The third inclined surface 33521′ is provided so that the hook 3352′ is in line contact with the first inclined surface 3331′, and the friction between the hook 3352′ and the first inclined surface 3331′ is reduced, so that it is easier for the first inclined surface 3331′ to push the hook 3352′.

In some embodiments, the third inclined surface 3351′ is parallel to the first inclined surface 3331′ when the hook 3352′ is clamped onto the second inclined surface 3332′.

In some embodiments, the resilient member 337′ is a spring.

In some embodiments, in order to prevent the resilient member 337′ from springing out during the rotation of the rotating body 335′, the second end 3353′ of the rotating body 335′ and the second fixed block 332′ are respectively provided with a first mounting groove 33531′ and a second mounting groove 3322′. The resilient member 337′ is interposed between the first mounting groove 33531′ and the second mounting groove 3322′.

It will be appreciated that when the hook 3352′ is clamped with the locking block 333′, the resilient member 337′ is in its original long or compressed state.

It should be noted that, in order to ensure the implementability of the solution, when the rotating body 335′ is not in contact with the locking block 333′. Namely, when the resilient member 337′ is not elastically deformed, the hook 3352′ should be located above the second fixed block 332′. The angle between the upper end face or the third inclined surface of the rotating body and the plane where the second fixed block 332′ is located is a pre-set angle which can be set according to actual situations, so as to ensure that when the second fixed seat 322 rotates close to the first fixed seat 321, the hook 3352′ can be in contact with the first inclined surface 3331′.

In some embodiments, in order to prevent the rotating body 335′ from rotating under an external force after the hook 3352′ is clamped with the locking block 333′, the locking assembly 320′ further includes a locking knob 338′. The second end of the rotating body is provided with a fourth mounting hole 33532′. The locking knob 338′ is threadedly connected to the fourth mounting hole 33532′. After the hook is clamped with the locking block 333′, the locking knob 338′ is tightened until the end of the locking knob 338′ abuts against the second fixed block 332′. In some embodiments, the end of the locking knob 338′ has an arc surface.

Note that the first mounting groove 33531′ is provided close to a middle part 3351′ of the rotating body. The fourth mounting hole 33532′ is provided away from a middle part 3351′ of the rotating body.

For convenience of description, the hinge assembly 320 and the locking assembly 330 at the junction of the connecting portion 314 and the right crossbeam portion 316 are described as examples. The direction of rotation close to the second fixed seat 322′ is a counterclockwise direction, and the direction of rotation away from the second fixed seat 322 is a clockwise direction.

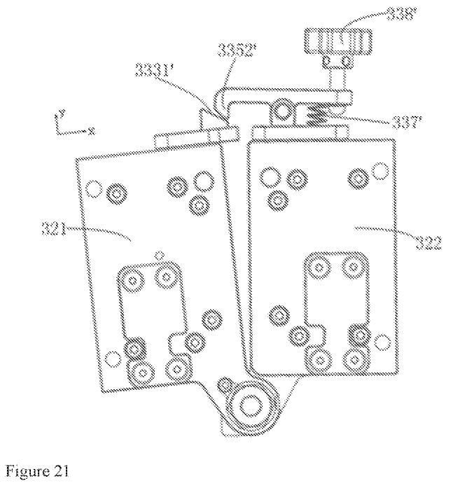

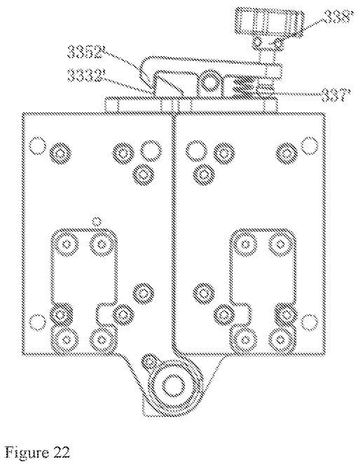

In particular, the first fixed seat 321′ is pushed to rotate the first fixed seat 321′ in a direction close to the second fixed seat 322′ until the hook 3352′ abuts against the first inclined surface 3331′, as shown in FIG. 21. It continues to push the first fixed seat 321′ towards the second fixed seat 322′. The first inclined surface 3331′ pushes against the hook 3352′ under the push of the first fixed seat 321′. The hook 3352′ rotates clockwise under the action of the first inclined surface 3331′ and compresses the resilient member 337′, as shown in FIG. 22, until the first fixed seat 321′ is flush with the second fixed seat 322′. The rotating body 335′ rotates counterclockwise under the action of the restoring force of the resilient member 337′, so that the hook 3352′ is clamped to the second inclined surface 3332′. The locking knob 338′ is tightened until the end of the locking knob 338′ abuts against the second fixed block 332′ to complete locking. When it is necessary to unlock, namely, the first fixed seat 322′ needs to rotate in a direction away from the second fixed seat 322′, the locking knob 338′ is unscrewed so that the end of the locking knob 338′ is at a pre-set distance from the second fixed block 332′. By pressing the locking knob 338′, the rotating body 335′ rotates in the clock wise direction until the hook 3352′ is disengaged from the second inclined surface 3332′, at which time the first fixed seat 321′ can rotate in the clockwise direction. It will be appreciated that the pre-set distance is greater than the distance of the end of the hook 3352′ from the top of the locking block 3332′ when the hook 3352′ is clamped onto the second inclined surface 3332′.

Referring again to FIG. 16, in some embodiments, in order to accurately know whether the left crossbeam portion 312 and the right crossbeam portion 316 rotates to an extreme position connected to the connecting portion 314, the crossbeam module 300 further has a detection sensor 301 mounted to the crossbeam 310 for detecting whether the left crossbeam portion 312 and the right crossbeam portion 316 are closed to the connecting portion 314. In the present embodiment, the detection sensor 301 is a proximity sensor. An end portion of the left crossbeam portion 312 is provided with a first mounting groove 3121. An end portion of the connecting portion 314 is provided with a second mounting groove 3141. The left crossbeam portion 312 is mounted with a stop block 3122 at the first mounting groove 3121 close to the connecting portion 314. The connecting portion 314 is mounted with a support 3142 in the second mounting groove 3141. The proximity switch is supported by the support 3142. When the left crossbeam portion 312 rotates to a level with the connecting portion 314, the proximity switch will detect that the stop block 3122 is in place, determining that the left crossbeam portion 312 has been rotated to the limit position locked with the connecting portion 314. In this embodiment, the first mounting groove 3121 is covered by the first fixed seat 321, without being exposed to the outside. The second mounting groove 314 is covered by the second fixed seat 322, without being exposed to the outside, so that it is more advantageous to create a detection environment of the detection sensor so as to prevent the detection from being abnormal due to the excessive illumination from the outside. Similarly, a structure like a first mounting groove 3121, a second mounting groove 3141, a stop block 3122 and a proximity switch is provided between the right crossbeam portion 316 and the connection part 314 to determine whether the right crossbeam portion 316 rotates to an extreme position connected to the connecting portion 314.

Referring again to FIG. 14, in some embodiments, the crossbeam module 300 further includes a buffer member 340 mounted to the crossbeam 310 to slow the rotational speed of the left crossbeam portion 312 and the right crossbeam portion 316 relative to the connecting portion 314. In this embodiment, the buffer member 340 is a gas spring having one end connected to the left crossbeam portion 312 and the other end connected to the connecting portion 314. In this manner, as the crossbeam 310 is closed, the left crossbeam portion 312 rotates relative to the connecting portion 314, at which time the left crossbeam portion 312 will slowly move downwards in a direction towards the ground until it moves to an extreme position, avoiding the left crossbeam portion 312 from suddenly falling downwards in a direction towards the ground, exacerbating the loss of the hinge assembly 320. It should be understood that the buffer member 340 is not limited to the gas spring described above, but may be other structures, such as a tension spring or a rubber ring, etc., as long as the slowing down of the left crossbeam portion 312 towards the base module 100 is achieved.

In some embodiments, the connecting portion 314 is provided with a first slide groove 3144. The left crossbeam portion 312 and the right crossbeam portion 316 are provided with a second slide groove 3124. Two of the second slide grooves 3124 are respectively located at two ends of the first slide groove 3144, and the first slide groove 3144 communicates with the two second slide grooves 3144.

In order to more accurately control the position of the calibration elements on the crossbeam module 300 to improve the accuracy of the ADAS calibration, the crossbeam module 300 further includes a hanging and mounting mechanism mounted to the crossbeam 310 for hanging and mounting the calibration elements.

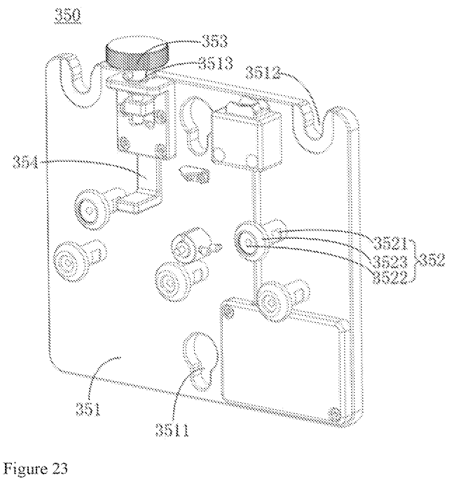

As shown in FIG. 23, the hanging and mounting mechanism includes a primary slide assembly 350 mounted to the crossbeam 310. Here, the crossbeam 310 is reciprocally movable in an axial direction of the crossbeam 310. Specifically, the primary slide assembly 350 includes a primary slide 351 and at least two roller members 352. One end of the at least two roller members 352 is mounted on the primary slide 351, and the other end of the at least two roller members 352 is mounted in the first slide groove 3144. In this manner, the primary slide 351 may slide within the first slide groove 3144 via the roller member 352 to provide different hanging positions for the calibration element. In the present embodiment, the primary slide 351 is provided with two gourd-shaped mounting holes 3511. The two mounting holes 3511 are symmetrically distributed, and the mounting holes 3511 are used for a user to hang and mount the calibration element. The hanging and mounting may be achieved by means of a hook or the like. Further, the primary slide 351 is also provided with arc holes 3512. The number of the arc holes 3512 is two, two arc holes 3512 are symmetrically distributed, and the arc holes 3512 can also be used for hanging and mounting the calibration element.

The roller member 352 includes a connection rod 3521, a bearing 3522 and a wheel sleeve 3523. One end of the connection rod 3521 is fixedly connected to the primary slide 351, and the other end of the connection rod 3521 is connected to the bearing 3522. The wheel sleeve 3523 is sleeved on the bearing 3522. In this manner, when the primary slide 351 is pushed, the bearing 3522 and the wheel sleeve 3523 will roll relative to the connection rod 3521, thereby achieving movement of the primary slide 351.

It should be understood that although the above-described embodiment mentions that the mounting holes 3511 have a shape of a gourd shape and a number of two, the shape and number of the mounting holes 3511 are not limited thereto as long as they can be hung and mounted by the calibration element. Also, the number of the arc holes 3512 is not limited to the above-mentioned two.

Further, the primary slide assembly 350 includes a screw rod member 353 and a retainer 354. The primary slide 351 is provided with a screwed hole 3513. The screw rod member 353 is threadedly connected to the screwed hole 3513, and the screw rod member 353 is connected to the retainer 354. In the present embodiment, the primary slide 351 is provided with a mounting portion on which the screwed hole 3513 is provided. One end of the screw rod member 353 is a screw cap, and the other end of the screw rod member 353 is a screw rod having threads, and an outer surface of the screw rod has threads. The screw rod passes through the screwed hole 3513 and is fixedly connected to the retainer 354.

Thus, when the screw rod member 353 is screwed in a first direction, the retainer 354 gradually moves towards and abuts against the groove wall of the first slide groove 3144, so that the primary slide 351 is in a locked state. At this time, the primary slide 351 cannot move freely, and it can effectively ensure that the position of the calibration element does not change when performing ADAS calibration. When the screw 353 is screwed in the second direction, the retainer 354 gradually moves away from the groove wall of the first slide groove 3144, so that the primary slide 351 is in an unlocked state. At this time, the primary slide 351 may slide along the first slide groove 3144. It should be understood that the first direction and the second direction are two opposite directions, e.g., the first direction is a clockwise direction and the second direction is a counterclockwise direction.

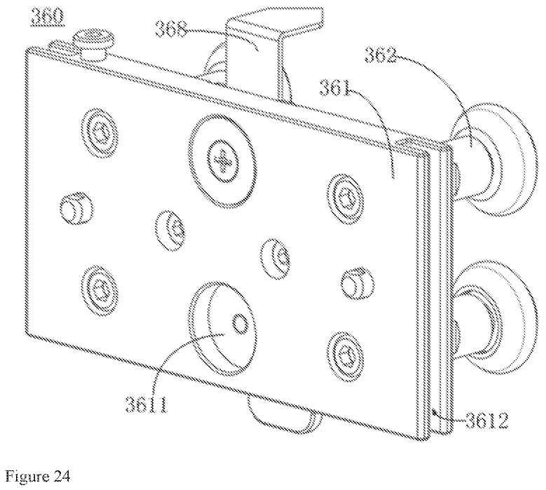

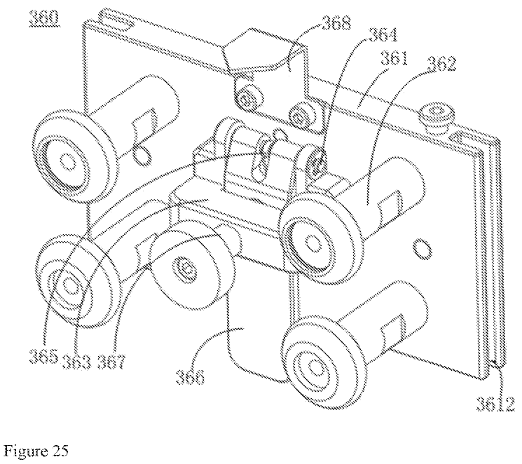

As shown in FIGS. 24-25, in some embodiments, the hanging and mounting mechanism further includes two auxiliary slide assemblies 360 mounted to the second slide groove 3124 and slidable on the second slide groove 3124. In the present embodiment, one group of the auxiliary slide assemblies 360 is disposed on the left crossbeam portion 312 and the right crossbeam portion 316. The two groups of the auxiliary slide assemblies 360 cooperate to hang and mount the calibration elements.

Specifically, the auxiliary slide assemblies 360 includes an auxiliary slide 361 and at least two pulley rods 362, one end of each of which is detachably mounted to the auxiliary slide 361, and the other end of each of which is mounted in the second slide groove 3124. Thereby, the auxiliary slide 361 may slide in the second slide groove 3124 by means of the pulley rod 362 to provide different hanging and mounting positions for the calibration element.

An end of the auxiliary slide 361 away from the second slide groove 3124 is provided with two embedded openings 3611. A magnetic piece is embedded in the embedded openings 3611, and the magnetic piece can be used for attracting the calibration element. In this case, the calibration element is required to be made of a magnetic material or have a region where a part of the calibration element can be magnetically attracted. The magnetic pieces on the two auxiliary slides 361 jointly attract the calibration element so as to play the role of mounting and hanging the calibration element. The magnetic member may be a magnet or other object having magnetic properties. Further, the side end of the auxiliary slide 361 is provided with a rabbet 3612 which is used for clamping the calibration element. In particular use, two ends of the calibration element are respectively received by the rabbets 3612 on the two sliding plates 361 so as to jointly clamp the calibration element. Here, the rabbets 3612 of two of the sliding plates 361 are required to simultaneously face towards the position where the fixed column 210 is located in the middle.

The pulley rod 362 is similar in structure to the roller member 352 in that they are rolled by means of a bearing, and a detailed description of the pulley rod 362 will not be given here.

It should be appreciated that in order to know the position of the primary slide assembly 350 and the auxiliary slide assembly 360 on the crossbeam 310, the crossbeam 310 is provided with a scale bar 318 having a scale. In this embodiment, the scale bar 318 is disposed along the axial direction of the crossbeam 310.

As shown in FIG. 25, the auxiliary slide assembly 360 further includes a stop structure mounted to the auxiliary slide plate 361 for stopping the auxiliary slide plate 361 from random movement resulting in inaccurate ADAS calibration. In the present embodiment, the stop structure includes a mounting seat 363, a support shaft 364, a torsion spring 365, a spanner 366 and a stop piece 367. The mounting seat 363 is mounted on the auxiliary slide 361. The support shaft 364 is mounted on the mounting seat 363. The torsion spring 365 and the spanner 366 are sleeved on the support shaft 36. One end of the torsion spring 365 abuts against the auxiliary slide 361, and the other end of the torsion spring 365 abuts against the spanner 366. One end of the stop piece 367 is connected to the spanner 366, and the other end of the stop piece 367 abuts against the crossbeam 310. Thus, under the action of the stop piece 367, the auxiliary slide 361 is blocked from being freely moved, and is in a locked state. When the spanner 366 is wrenched, the spanner 366 causes the stop piece 367 to move in a direction away from the crossbeam 310, so that the auxiliary slide 361 may slide in the second slide groove 3124 via the pulley rod 362, releasing the spanner 366. Under the action of the torsion spring 365, the spanner 366 will push the stop piece 367 to move in a direction close to the crossbeam 310 and abut against it, so that the auxiliary slide 361 returns to a locked state.

In some embodiments, the auxiliary slide assembly 360 further includes a pointer member 368 removably mounted to the auxiliary slide 361 for indicating a scale position of the auxiliary slide 361 on the crossbeam 310. Namely, the distance moved by the auxiliary slide 361 or the distance from the center of the crossbeam 310 may be known according to the scale of the scale bar 318 indicated by the pointer member 368.

With the above structure, when the user needs to adjust the position of the auxiliary slide 361, the locking state of the auxiliary slide 361 is released by the spanner 366 before the auxiliary slide 361 can be moved. In this way, the position of the auxiliary slide 361 may be effectively locked, and the stability during the ADAS calibration may be improved.

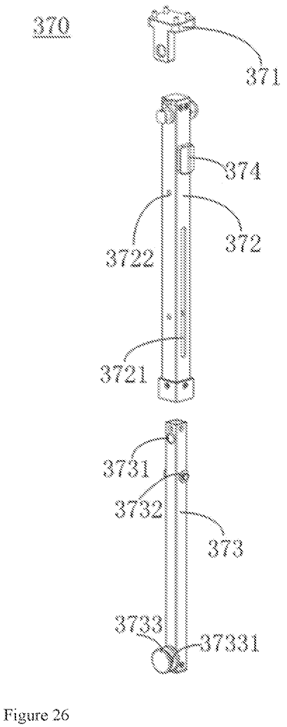

As shown in FIG. 26, in some embodiments, the hanging and mounting mechanism further includes a suspension rod assembly 370 mounted to the crossbeam 310. The suspension rod assembly 370 is used for supporting the indexing element. Specifically, the suspension rod assembly 370 includes a connection block 371 mounted to the crossbeam 310, a receiving rod 372 connected to the connection block 371, the receiving rod 372 being provided with a receiving space, and a support rod 373 which is received in the receiving space and can be extended or retracted relative to the receiving rod 372, the support rod 373 being used for supporting the calibration element.

The receiving rod 372 has a sliding hole 3721 and a positioning hole 3722. The sliding hole 3721 is in the shape of an elongated hole, and the sliding hole 3721 is disposed along the axial direction of the receiving rod 372. The sliding holes 3721 are disposed at two opposite side ends of the receiving rod 372. The number of the positioning holes 3722 is two, and the two positioning holes 3722 are disposed along the axial distance of the receiving rod 372.

The support rod 373 is provided with a spring bead 3731, a guide shaft 3732 and a suspension block 3733. The spring bead 3731 is located at one end of the support rod 373, and the suspension block 3733 is located at the other end of the support rod 373. The guide shaft 3732 is located between the spring bead 3731 and the suspension block 3733. The guide shaft 3732 passes through the opposite ends of the support rod 373, and the ends of the guide shaft 3732 both protrude out of the sliding hole 3721. Here, the spring bead 3731 may protrude out of the receiving space and be inserted into the positioning hole 3722 so as to adjust the length of the support rod 373 extending out of the receiving rod 372. The suspension block 3733 is provided with a snap-fit groove 37331. The snap-fit groove 37331 is used for clamping the calibration element.

When the user pulls the support rod 373, the spring bead 3731 is retracted into the receiving space. Under the action of the guide shaft 3732, the support rod 373 is directionally drawn out of the receiving rod 372 along the sliding hole 3722 until the spring bead 3731 is again inserted into another positioning hole 3722. Adjustment of the length of the support rod 373 is achieved to better hang and attach the calibration elements as required.

It should be understood that the number of the positioning holes 3722 is not limited to the two mentioned in the above embodiment, and may be increased as needed. The adjustment structure of the support rod 373 relative to the receiving rod 372 is not limited to the form of a spring bead and a positioning hole, as long as the structure for adjusting the length of the support rod 373 relative to the receiving rod 372 can be applicable. For example, a pin shaft and a pin hole can be inserted into each other. In this case, the receiving rod 372 is provided with a plurality of pin holes along the axial direction thereof. The support rod 373 is also provided with a plurality of pin holes. The relative lengths of the two can be fixed by inserting the pin shaft through the pin holes at different positions of the receiving rod 372 and the support rod 373.

In some embodiments, the connection block 371 is hinged to the receiving rod 372. The suspension assembly 370 further includes a magnet piece 374. A magnetic block (not shown) is mounted on the crossbeam 310. The magnet piece 374 and the magnetic block are both magnetic, and the magnet piece 374 and the magnetic block are magnetically attracted. As such, when the receiving rod 372 rotates towards the direction close to the crossbeam 310, the magnet piece 374 is magnetically attracted to the magnetic block so that the receiving rod 372 may be foldably received relative to the crossbeam 310. In the embodiment, the connection block 371 and the magnetic block are both mounted to the connecting portion 314 such that, when the crossbeam 310 is in the folded state, the receiving rod 372 may also magnetically engage with the magnetic block via the magnet piece 374. Thus, the receiving rod 372 and the connecting portion 314 are approximately in the same horizontal line, thereby minimizing the volume of the vehicle measurement apparatus 900 and stabilizing the receiving rod.

It will be appreciated that the calibration element may be supported in a variety of ways. For example, (1) the suspending is achieved by two of the mounting holes 3511 or the two arc holes 3512 on the primary slide 351; (2) the calibration element is attracted by the magnetic pieces mounted on two of the auxiliary slides 361; (3) the calibration element is clamped by the rabbets 3612 on the sides of two of the secondary sliding blocks 361; and (4) it is supported by the rabbets 3612 on the sides of the two auxiliary sliding blocks 361 and the two suspension assemblies 370.

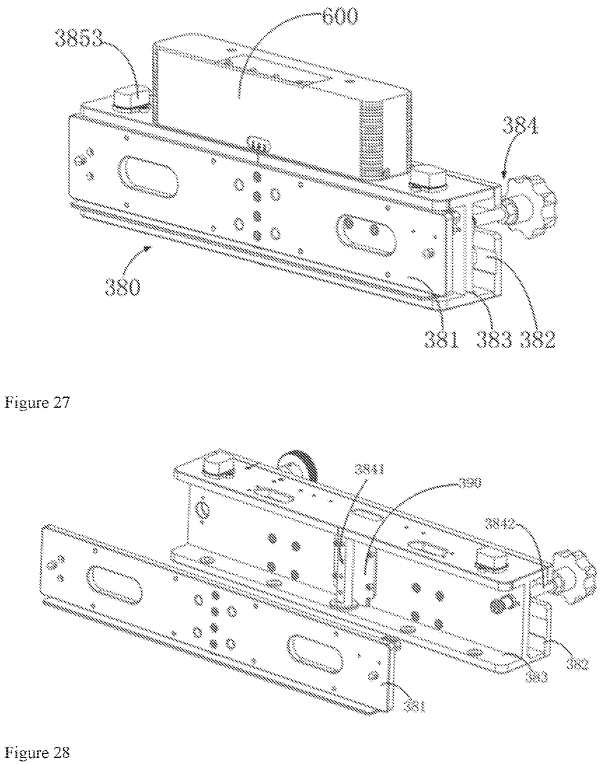

Referring to FIGS. 27-29, in some embodiments, the crossbeam module 300 further includes an adjustment unit that includes an adjustment mechanism 380 connected to the mobile column assembly 220. The crossbeam 310 is mounted to the adjustment mechanism 380 used for adjusting the position of the crossbeam relative to the fixed column.

The adjustment mechanism 380 includes a first connection plate 381 connected to the crossbeam 310, a second connection plate 382 connected to the elevating plate 223, a supporting plate 383 located between the first connection plate 381 and the second connection plate 382, and an adjustment assembly 384 mounted to the first connection plate 381, the second connection plate 382, and the supporting plate 383. The adjustment assembly 384 is used for adjusting the relative position between the crossbeam 310 and the fixed column 210. In this embodiment, the supporting plate 383 is “I” shaped. Of course, the shape of the supporting plate 383 may be other shape, and is not limited to the I-shape in this embodiment.

In some embodiments, in order to enable the crossbeam 310 to better fit closely with the first connection plate 381 and facilitate mounting, a bracket (not shown) is mounted at the bottom of the first connection plate 381, and both ends of the bracket protrude from the edge of the first connection plate 381, so that the bracket may support the bottom of the crossbeam 310 when the first connection plate 381 fits closely with the crossbeam 310, thereby achieving quick positioning and mounting.

The adjustment assembly 384 includes a rotating shaft 3841, a first drive rod 3842, an elastic member 3843 and a mounting rod 3844. The rotating shaft 3841 is rotatably mounted at the middle of the supporting plate 383. The first connection plate 381 is connected with the rotating shaft 3841. The first drive rod 3842 is threadedly connected to the supporting plate 383, and one end of the first drive rod 3842 is connected to one end of the first connection plate 3841. The mounting rod 3844 is mounted at the other end of the first connection plate 381, with the mounting rod 3844 facing towards the supporting plate 383. The elastic member 3843 is sleeved on the mounting rod 3844.

When a user twists the first drive rod 3842, and moves one end of the first connection plate 381 away from the supporting plate 383, under the action of the rotating shaft 3841, the other end of the first connection plate 381 moves closer to the supporting plate 383 and presses the elastic member 3843, so that the first connection plate 381 drives the crossbeam 310 to rotate around the fixed column 210. On the contrary, when the first drive rod 3842 is screwed in the reverse direction, one end of the first connection plate 381 moves in a direction close to the fixed column 210, and the other end of the first connection plate 381 moves in a direction away from the supporting plate 383 by the elastic member 3843, so that the vertical distance between the left crossbeam portion 312 and the fixed column 210 may be adjusted as needed. In this embodiment, the elastic member 3843 is a spring. Of course, the elastic member 3843 is not limited to the spring in the present embodiment. For example, the elastic member 3843 may be silica gel or the like.

Thus, the adjustment mechanism may effect adjustment of the rotation angle of the crossbeam relative to the column module, i.e., effect the rotation of the crossbeam 31 about the central axis of the column module 200.

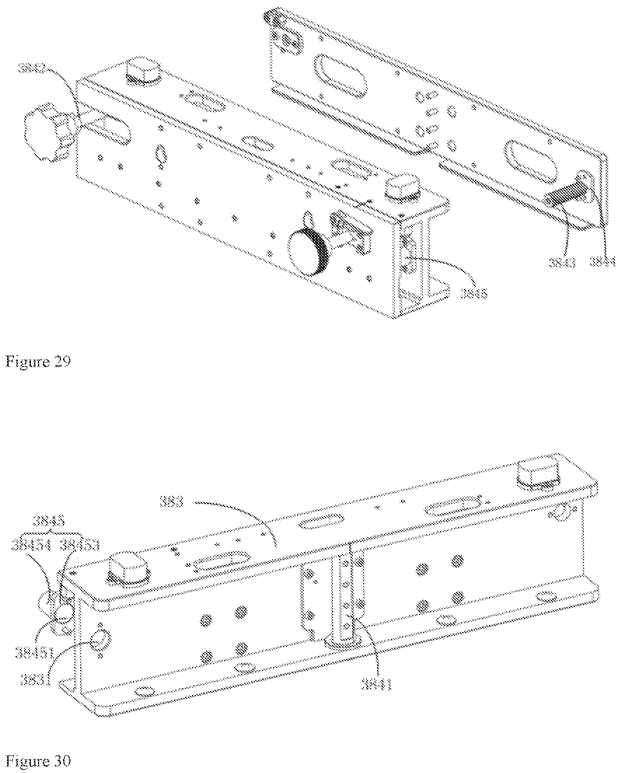

As shown in FIG. 29, the adjustment assembly 384 further includes a receiving member 3845, one end of which has an opening 38451. The supporting plate 383 is provided with a communication hole 3831. The receiving member 3845 is mounted to the supporting plate 383. The opening 38451 communicates with the communication hole 3831. The elastic member 3843 is partially received in the receiving member 3845. One end of the elastic member 3843 abuts against a bottom of the receiving member 3845, and the other end of the elastic member 3843 abuts against the first connection plate 381. Here, the hole diameter of the communication hole 3831 should be greater than the shaft diameter of the mounting rod 3844, so that the first connection plate 381 has a movable space when driving the mounting rod 3844 to rotate. In the present embodiment, the receiving member 3845 includes a boss 38453 and a cylinder body 38454. The cylinder body 38454 is connected to the boss 38453. One end portion of the cylinder body 38454 is provided with an opening 38451 which extends through the boss 38453. The elastic member 3843 is received in the cylinder body 38454. One end of the elastic member 3843 abuts against the bottom of the cylinder body 38454 and the other end abuts against the first connection plate 381. As such, when the other end of the first connection plate 381 presses the elastic member 3843, the elastic member 3843 is compressed towards the inside of the cylinder body 38454, so that the first connection plate 381 has more movable strokes.

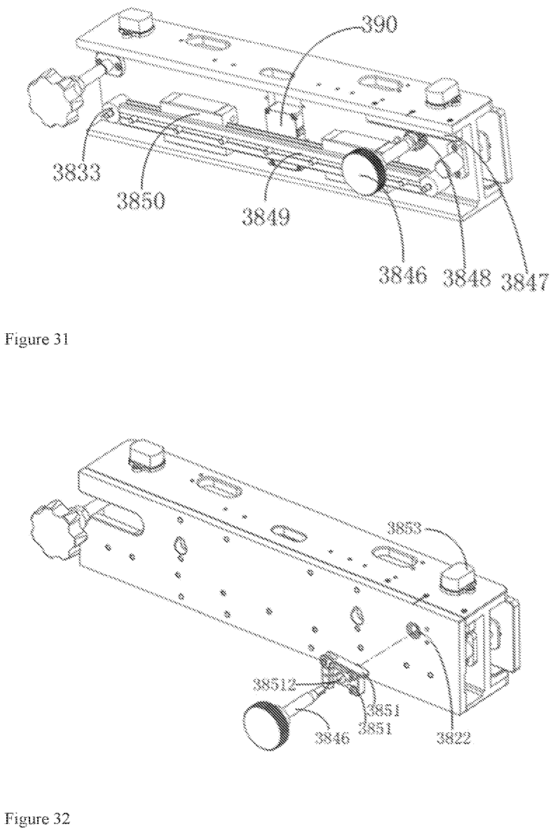

As shown in FIG. 31, in some embodiments, the adjustment assembly 384 further includes a second screw 3846, a rack 3847, a gear 3848, and a sliding bar 3849. The sliding bar 3849 is mounted to the supporting plate 383, and the sliding bar 3849 is slidable in a pre-set direction relative to the supporting plate 383. The second connection plate 382 is connected to the sliding bar 3849. The rack 3848 is mounted on the supporting plate 383. The second connection plate 382 is provided with an avoidance hole 3822. One end of the second screw rod 3846 is mounted with the gear 3848, and the other end of the second screw rod 3846 passes through the avoidance hole 3822. The gear 3848 meshes with the rack 3847. Thus, when the second screw 3846 is screwed, the gear 3848 drives the rack 3847 to move the supporting plate 383 in the pre-set direction. In this embodiment, the pre-set direction is a direction in which the I-shaped supporting plate 383 is stretched. The sliding bar 3849 is slidably mounted on the supporting plate 383 by providing a guide slipper 3850 with a convex surface on the supporting plate 383 and providing a groove on the guide slipper 3850. The sliding bar 3849 is cooperatively mounted with the guide slipper 3850. The sliding bar 3849 may slide through the groove.

If the pre-set direction is on the same horizontal line as the direction of the crossbeam 310, the second screw 3846 is screwed, i.e., the crossbeam 310 can be moved leftwards or rightwards relative to the fixed column 210, thereby adjusting the distance between the center of the left crossbeam portion 312 and the center of the right crossbeam portion 316 to the central axis of the fixed column 210.

Furthermore, in order to prevent the supporting plate 383 from disengaging from the second connection plate 382 driven by the second screw 3846, a limit block 3833 is disposed on the supporting plate 383. The number of the limit blocks 3833 is two, and two of the limit blocks 3833 are respectively located at two ends of the sliding bar 3849. In this way, limited by the limit block 3833, the guide slipper 3850 can only move for a certain stroke, avoiding the guide slipper 3850 from disengaging from the guide sliding bar 3849. At the same time, the stroke of the rack 3848 moving left and right for is the same as the stroke that the guide slipper 3850 can move for.

As shown in FIG. 32, in some embodiments, the adjustment assembly 384 further includes a locking structure mounted to the second connection plate 382 for locking the second screw 3846 to prevent rotation of the second screw 3846 due to a human error. In this embodiment, the locking structure includes a hoop piece 3851 and a locking member 3852. The hoop piece 3851 has an annular hole 38512. The hoop piece 38512 is sleeved on the second screw 3846 via the annular hole 38512. The hoop piece 3851 is fixedly mounted on the second connection plate 382. The locking member 3852 is hinged with the hoop piece 3851. Here, the diameter of the annular hole 38512 is greater than the shaft diameter of the second screw 3846. The locking member 3852 has a cam shape at one end for connecting with the hoop piece 3851.

When the locking member 3852 is in a first position, in which the locking member 3852 does not compress the hoop piece 3851 to screw the second screw 3846, the supporting plate 383 is movable relative to the second connection plate 382. Turning the locking member 3852 to the second position, the locking member 3852 will compress the hoop piece 3851 and cause the hole wall of the annular hole 38512 to closely fit with the second screw 3846, which will now be in the locked condition.

In some embodiments, the adjustment mechanism further includes a level bead 3853 mounted to the supporting plate 383, the level bead 3853 configured for detecting whether the crossbeam 310 is in a level condition. If the level bead 3853 indicates that the crossbeam 310 is not horizontal, the adjustment may be made by adjusting the foot cup 113 of the base module 100 until the level bead 3853 indicates that the crossbeam 310 is in a level condition. Thus, it is possible to effectively reduce the error generated during the calibration of the vehicle measurement apparatus 900.

As shown in FIG. 28 or 31, in some embodiments, the supporting plate 383 is provided with an accommodating cavity (not shown). The crossbeam module 300 further includes a laser 390 received in the accommodating cavity and fixedly connected to the supporting plate 383, the laser 390 being used to measure the height of the crossbeam 310 from the ground.

With the above-described structure, the adjustment mechanism may realize the adjustment of the transverse crossbeam 31 to move left and right in the direction of the central axis thereof, and at the same time, may achieve the rotation of the transverse crossbeam 31 in the direction of the central axis of the column module 200.

Referring again to FIG. 13, in some embodiments, the camera assembly 400 includes a first camera 410 mounted to the left crossbeam portion 312, e.g., at an end of the left crossbeam portion 312, and a second camera 420 mounted to the right crossbeam portion 316, e.g., at an end of the right crossbeam portion 316, for acquiring an image of a wheel on both sides of the vehicle, or an image of a target close to or attached to the wheel on both sides of the vehicle, respectively. Further, the camera assembly 400 also includes a third camera 430 mounted to the connecting portion 314 for acquiring an image of a head region of the vehicle. The first, second and third cameras may be detachably mounted to the crossbeam, or the first, second and third cameras may be fixedly mounted to the crossbeam.

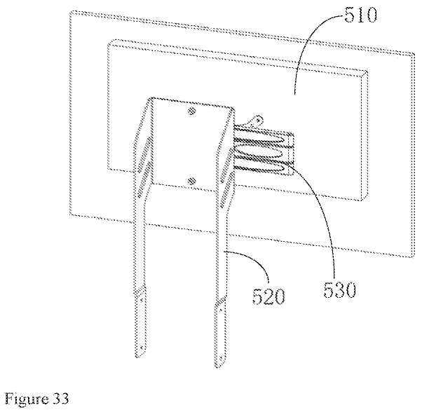

As shown in connection with FIG. 33, in some embodiments, the vehicle measurement apparatus 900 further includes a display assembly 500 connected to the fixed column 210 for displaying images acquired by the camera assembly. Specifically, the display assembly 500 includes a display screen 510 and a fixed support 520, the fixed support 520 being mounted to the fixed column 210, and the display screen 520 being mounted to the fixed support 520.

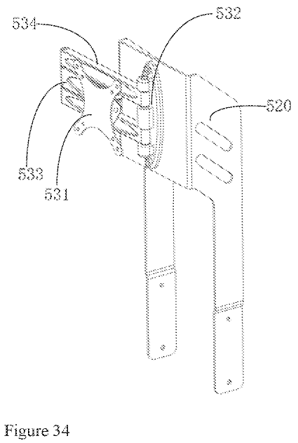

Further, the display assembly 500 further includes a folding support 530, and as shown in FIG. 34, the folding support 530 includes a first fixed piece 531, a second fixed piece 532, a first supporting arm 533 and a second support arm 534. The first fixed piece 531 is fixedly connected to the display screen 510. One end of the first supporting arm 533 is hinged to the first fixed piece 531, and the other end of the first supporting arm 533 is hinged to one end of the second supporting arm 534. The other end of the second supporting arm 534 is connected to the second fixed piece 532. The second fixed piece 532 is connected to the fixed support 520. Here, the second supporting arm 534 is rotatable relative to the first fixing plate 531, and the first supporting arm 533 is rotatable relative to the second supporting arm 534. Since the first supporting arm 533 and the second supporting arm 534 are both rotatable, the display screen 510 will have different distances from the fixed column 210 depending on the user's needs. When the folding support 530 is not used, the display assembly 500 is located at a side facing away from the crossbeam module. When the folding support 530 is used, the display assembly 500 may rotate to the same side as the crossbeam module, i.e., a side facing towards the vehicle, so that a user can observe a measurement result or a maintenance result in real time while measuring or maintaining the vehicle.

In some embodiments, the vehicle measurement apparatus 900 further includes a main control 600. The main control 600 is mounted on the supporting plate 383, and the main control 600 is connected to the display screen 510 and the first camera 410, the second camera 420 and the third camera 430, respectively. Here, the first camera 410, the second camera 420 and the third camera 430 may be wired or wirelessly connected to the main control 600. When wired, the electrical connection line between the above-mentioned cameras and the main control 600 is received inside the crossbeam 310. The main control 600 may be wirelessly connected to the display screen 510. The main control 600 is used for processing an image acquired by a camera to obtain processed data such as a measurement result, a calibration result and a guiding step, and transmitting the processed data to the display screen 510 for display. The user may make adjustments to the vehicle or vehicle measurement apparatus based on the data displayed on the display screen.

In some embodiments, the vehicle measurement apparatus 900 further includes a supporting bracket 700 mounted to the fixed column 210 for supporting a portable diagnostic device. Here, the display interface of the portable diagnostic device may be synchronized with the display interface of the display screen 510. The main control 600 may be wirelessly connected to the portable diagnosis device, and the main control 600 can be used for sending image data acquired by the camera to the portable diagnosis device for further processing by the portable diagnosis device, such as measuring wheel parameters, determining a calibration result, obtaining position information about the vehicle measurement apparatus relative to the vehicle, determining a user guidance operation step, etc.

The main control 600 of the present application may be electrically connected to all the electronic components involved in the present application, such as the above-mentioned control system, detection sensor, emergency control button, elevating button, etc. The main control may be used for receiving signals of the electronic components and issue instructions to the connected electronic components.

For example, upon receiving a signal transmitted by the emergency control button, the elevating button or the like, the main control may control the control system according to the specific signal, so that the control system controls the drive assembly to drive the emergency stop, lifting or lowering of the crossbeam module.

As another example, the main control may receive a signal from a detection sensor and determine that the crossbeam module is currently in an unfold state or in a folded state. If the main control detects that the crossbeam module is in the unfolded state, the control system may be allowed to start the drive assembly. If the main control detects that the crossbeam module is in the folded state, a command is not issued to the control system to enable the control system to start the drive assembly. Furthermore, the main control may also prompt a user to put the crossbeam module in the unfolded state via the display screen.

For another example, the main control may determine that the crossbeam module is currently in the unfolded state or the folded state according to the images acquired by the first camera and the second camera. For example, the first camera is provided with a self-calibration target. The second camera is provided with a self-calibration camera for capturing the self-calibration target. If the acquired image captured by the self-calibration camera contains the self-calibration target, it indicates that the crossbeam module is in an unfolded state. If the acquired image captured by the self-calibration camera does not contain the self-calibration target, it indicates that the crossbeam module is in a folded state.

Of course, other ways of data processing and transmission may be implemented by the main control, which is not limited herein.

In some embodiments, the vehicle measurement apparatus 900 further includes a handle 720 mounted to a side end of the fixed column 210.

### Embodiment 2

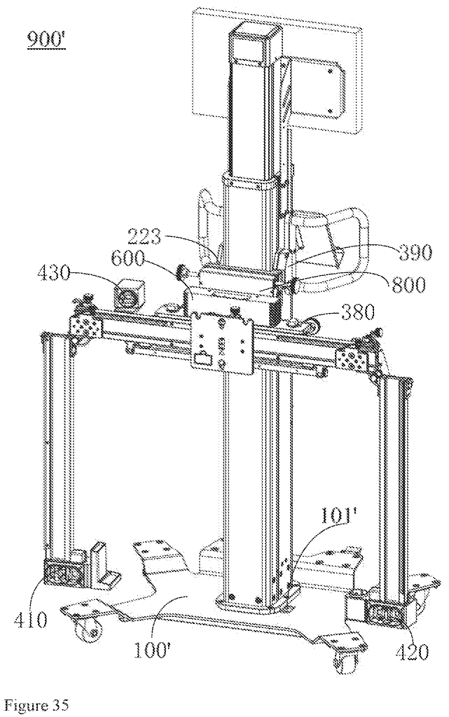

As shown in FIG. 35, another embodiment of the present invention provides a vehicle measurement apparatus 900′, which differs from the above-described embodiment in that the laser 390 is mounted at a side end of the elevating plate 223, the base module 100′ is provided with a through hole 101′ located directly below an emitting end of the laser; and the laser 390 is used for measuring the height of the crossbeam 310 from the ground. The laser 390 is disposed at a side end of the elevating plate 223, so as to facilitate maintenance and replacement of the laser 390 and at the same time facilitate adjustment of the light output angle of the laser 390.

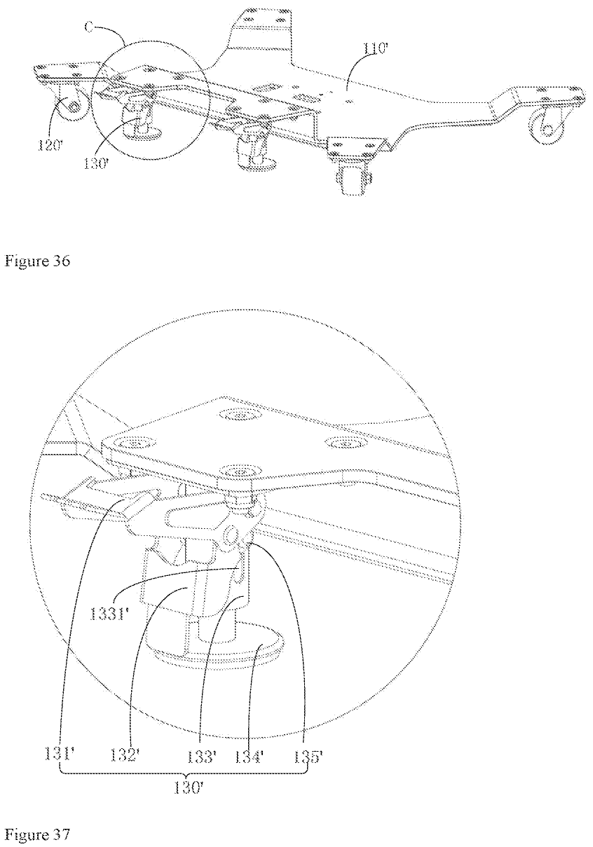

Referring to FIGS. 36 and 37, in some embodiments, the base module 100′ includes a base 110′, at least three universal wheels 120′ each mounted to the base 110′, and a foot brake assembly 130′ being mounted to the base 110′. The universal wheels 120′ are disposed in a polygonal shape at an end of the base 110′ away from the column module 200. In the present embodiment, the base 110′ is provided with the through holes 101′. The number of the universal wheels 120′ is four, and the four universal wheels 120′ are respectively distributed at four corners of the base 110′ so as to stably support other components away from the base module 100′ together.

The foot brake assembly 130′ includes a locking pedal 131′, an elastic pedal 132′, a storage cylinder 133′ mounted to the base 110′, the storage cylinder 133′ being provided with a guide groove 1331′, a stop block 134′ partially received in the storage cylinder 133′, and a connecting pin 135′ rotatably connected to the elastic pedal 132′. The connecting pin 135′ penetrates the storage cylinder 133′ and the stop block 134′. The locking pedal 131′ is hinged to the storage cylinder 133′ and the elastic pedal 132′, thereby forming a three-bar linkage. On the one hand, when the locking pedal 131′ gradually rotates in a direction close to the stop block 134′, the stop block 134′ gradually slides along the guide groove 1331′ and extends out of the storage cylinder 133′. The elastic pedal 132′ rotates in a direction away from the stop block 134′ around the central axis of the connecting pin 135′ until it passes the dead point. The stop block 134′ supports the base 110′, the universal wheel 120′ is stationary relative to the ground, and the foot brake assembly 130′ is in a stop state. Thus, by virtue of the frictional resistance of the stop block 134′ against the ground, the vehicle measurement apparatus 900′ may be prevented from freely moving to function as a brake. On the other hand, the elastic pedal 132′ is pressed, and the elastic pedal 132′ gradually approaches the storage cylinder 133′, so that the stop piece 134′ passes the dead point position of the three-link mechanism. The locking pedal 131′ rotates about the central axis of the connecting pin 135′ in a direction away from the stop block 134′, so that the stop piece 134′ retracts into the storage cylinder 133′. The locking pedal 131′ and the stop block 134′ are both reset, and the foot brake assembly 130′ is in a non-stop state, at which time the vehicle measurement apparatus 900 may be freely moved.

It should be appreciated that when the foot brake assembly 130′ is in a non-braking state, there is clearance between the stop piece 134′ and the ground, so that the user can freely move the vehicle measurement apparatus 900.

It should be noted herein that the shape of the stop block 134′ may be a straight rod shape or other shape as long as the stop piece can abut the ground when the foot brake assembly 130 is in the stop state. In the present embodiment, the shape of the stop block 134′ is an inverted “T” shape, i.e., the stop block 134′ includes a handle portion (not shown) and a flat portion (not shown) connected to the handle portion. The flat portion can make greater contact with the ground, reducing the influence of the vehicle measurement apparatus 900 on the ground, and preventing the ground from being damaged due to excessive weight.

In some embodiments, the adjustment unit also includes a fine-adjustment mechanism 800 mounted between the adjustment mechanism 380 and the column module 200. That is, one end of the fine-adjustment mechanism 800 is connected to the column module 200, and the other end of the fine-adjustment mechanism 800 is connected to the adjustment mechanism 380. At this time, the adjustment mechanism 380 is used to adjust the position of the crossbeam 310 relative to the column module 200. The fine-adjustment mechanism 800 is used to adjust a pitch angle, which is an angle at which the crossbeam 31 rotates about a first axis in a horizontal direction, and a roll angle, which is an angle at which the crossbeam 31 rotates about a second axial direction which is perpendicular to the first axis and the vertical direction. The pitch angle and the roll angle are formed by the displacement of the crossbeam 31 relative to the column module 200.

The adjustment mechanism 380 in the present embodiment has the following differences from the above-described embodiment.

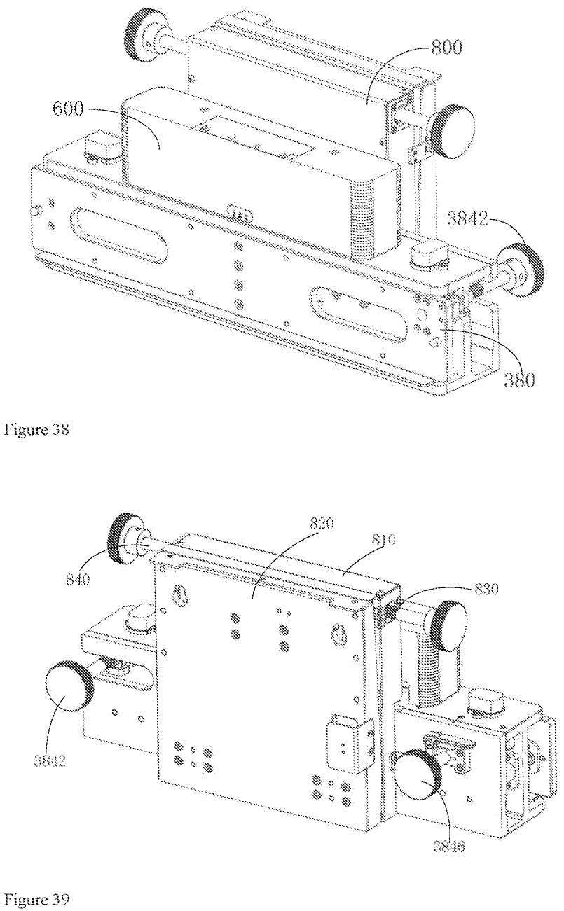

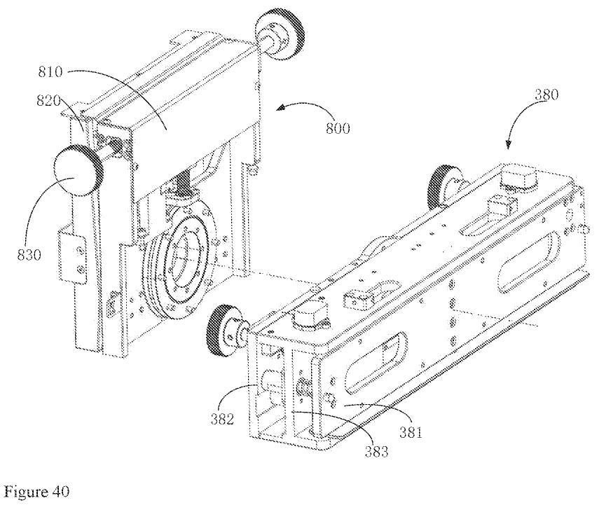

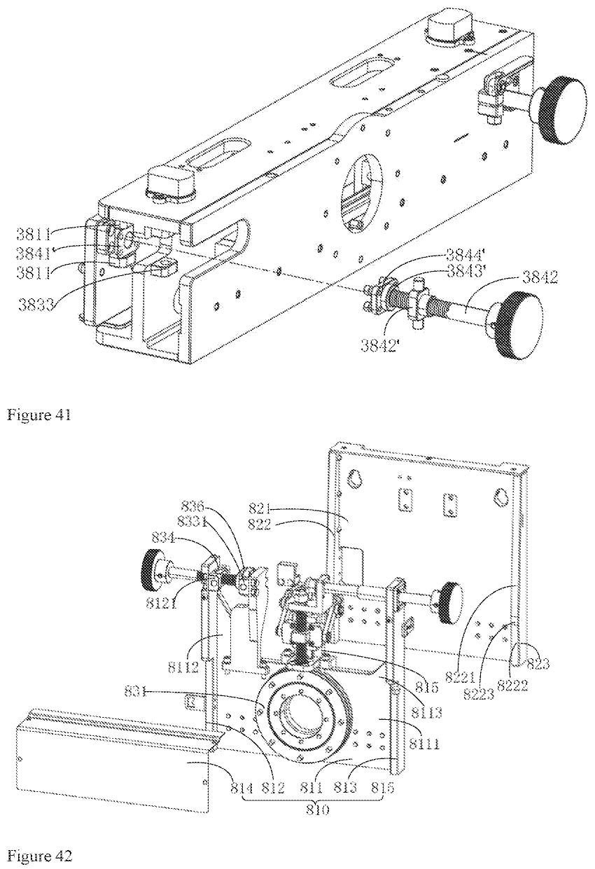

Referring to FIGS. 38-41, the adjustment assembly 384 further includes a third mounting block 3841′ rotatably mounted to the first connection plate 381, and the first drive rod 3842 is connected to the third mounting block 3841′. Here, a third gap exists between the third mounting block 3841′ and an end face of the first connection plate 381 facing towards the second connection plate 382. Specifically, one end face of the first connection plate 381 facing towards the second connection plate 382 is provided with two third protruding blocks 3811. Both of the two third protruding blocks 3811 are provided with a third limit hole (not marked). Two opposite ends of the third mounting block 3841′ are both provided with a third extension block (not marked). One of the third extension blocks (not marked) is inserted into the third limit hole of one of the third protruding blocks 3811, and the other of the extension blocks 3812 is inserted into the third limit hole of the other of the third protruding blocks 3811. As such, the third mounting block 3841′ is rotatable relative to the two third protruding blocks 3811.

When the first drive rod 3842 is driven to move one end of the first connection plate 381 away from the supporting plate 383, under the action of the rotating shaft 3841, the other end of the first connection plate 381 moves closer to the supporting plate 383 and presses the elastic member 3843, so that the first connection plate 381 rotates the crossbeam 31 about the central axis of the column module 200.

As can be appreciated, the provision of the third gap between the third mounting block 3841′ and the first connection plate 381 improves the ease with which the first drive rod 3842 drives the first connection plate 381, avoids jamming of the first drive rod 3842 during rotation of the first connection plate 381 about the central axis of the rotating shaft 3841, and enhances the stability of the adjustment mechanism 380.

In some embodiments, the adjustment assembly 384 further includes a fourth mounting block 3842′ rotatably mounted to the supporting plate 383. The fourth mounting block 3842′ is provided with an inner threaded hole (not shown). The outer surface of the first drive rod 3842 is threaded. The first drive rod 3842 is threadedly connected to the fourth mounting block 3842′. In the present embodiment, the supporting plate 383 is provided with two fourth protruding blocks 3833. The two of the fourth protruding blocks 3833 are provided with a fourth limit hole (not marked). The opposite ends of the fourth mounting block 3842′ are provided with fourth extension blocks (not marked). One of the fourth extension blocks is correspondingly inserted into one of the fourth limit holes, so that the fourth mounting block 3842′ may rotate relative to the supporting plate 383. Thus, the fourth mounting block 3842′ drives the first drive rod 3842 to rotate to accommodate the rotation of the third mounting block 3841′.

In some embodiments, an end of the first drive rod 3842 close to the third mounting block 3841′ is mounted with a bearing 3843′ and a bearing fixed seat 3844′ for fixing the bearing 3843′. The bearing fixed seat 3844′ is detachably mounted to the third mounting block 3841′.

When the first drive rod 3842 is screwed, the first drive rod 3842 approaches or moves away from the first connection plate 381. The thread of the inner threaded hole matches with the thread of the surface of the first drive rod 3842, so that the position of the first connection plate 381 may be finely adjusted.

In this embodiment, the vehicle measurement apparatus 900 may adjust the position of the crossbeam 31 relative to the column module 200 by providing the adjustment mechanism 380 to meet the position requirements of the crossbeam 31 for ADAS calibration or four-wheel positioning.

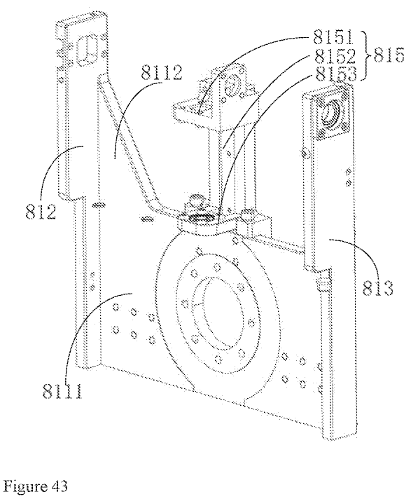

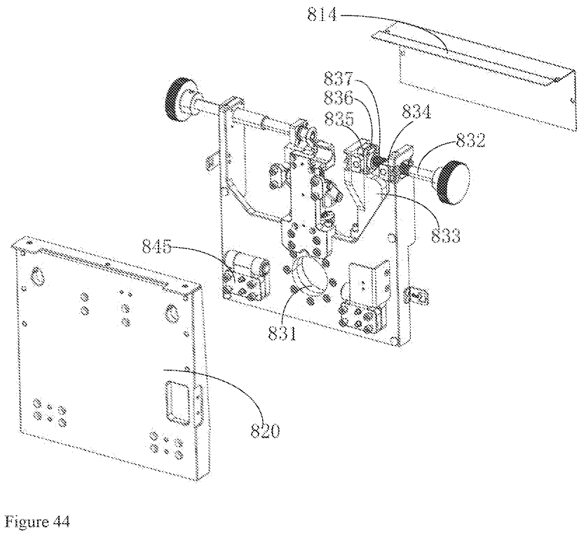

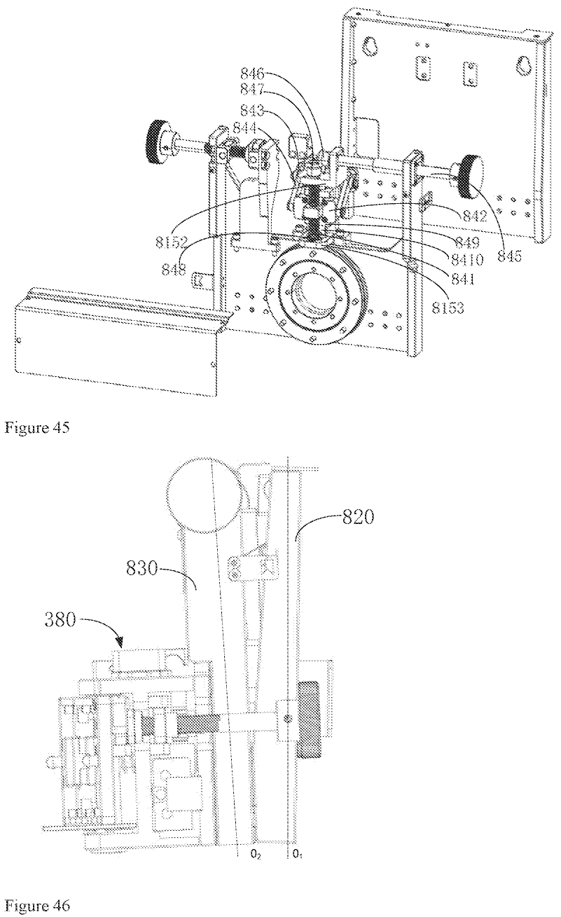

As shown in FIGS. 42-45, in some embodiments, the fine-adjustment mechanism 800 includes a first fine-adjustment plate 810, a second fine-adjustment plate 820 and a first fine-adjustment assembly 830. The first fine-adjustment plate 810 has one end rotatably mounted to the adjustment mechanism 380. The first fine-adjustment plate 810 has another end connected to one end of the second fine-adjustment plate 820. The second fine-adjustment plate 820 has another end connected to the elevating plate 223. The first fine-adjustment assembly 830 is mounted to the first fine-adjustment plate 810. The first fine-adjustment assembly 830 is used for rotating the adjustment mechanism 380 relative to the first fine-adjustment plate 810.

The first fine-adjustment plate 810 includes a first base plate 811, a first side plate 812, a second side plate 813, a blocking piece 814 and a mounting bar 815. Two ends of the first base plate 811 are respectively connected to the first side plate 812 and the second side plate 813. The first side plate 812 and the second side plate 813 are both connected to the blocking piece 814. The mounting bar 815 is mounted on the first base plate 811. Here, both the first side plate 812 and the second side plate 813 project an end surface of the first base plate 811 in the same direction, so that the first side plate 812, the second side plate 813 and the first base plate 811 enclose to form a chamber (not shown). The blocking piece 814 may occlude a portion of the chamber. In the present embodiment, the first base plate 811 includes a main base plate portion 8111, a first extension portion 8112 and a second extension portion 8113 extending from one end of the main base plate portion 8111. The region between the first extension portion 8112 and the second extension portion 8113 is hollowed out. One sides of the first side plate 812 and the second side plate 813 facing towards the adjustment mechanism 380 is provided with a shoulder portion (not shown). One end of the mounting bar 815 is connected to the main base plate portion 8111, and the other end thereof is disposed in a direction away from the main base plate portion 8111. Here, the mounting bar 815 includes a mounting bar body 8151, a first protruding portion 8152 and a second protruding portion 8153. The first protruding portion 8152 and the second protruding portion 8153 are both connected to the mounting bar body 8151.

The second fine-adjustment plate 820 includes a second base plate 821, a third side plate 822 and a fourth side plate 823. The third side plate 822 and the fourth side plate 823 are respectively connected to two opposite ends of the second base plate 821. One end face of the second base plate 821 is connected with the first base plate 811, and the other end face of the second substrate 822 is connected with the elevating plate 223. Here, the ends of the third side plate 822 and the fourth side plate 823 each have a first slope 8221, a second slope 8222 and a transition portion 8223. The transition portion 8223 is located between the first slope 8221 and the second slope 8222, where the slope length of the first slope 8221 is greater than the slope length of the second slope 8222.

The first fine-adjustment assembly 830 includes a rotational bearing 831, a first fine-adjustment screw rod 832, a drive block 833 and a first mounting block 834. The rotational bearing 831 is mounted on the first base plate 811. The rotational bearing 831 is connected to the adjustment mechanism 380. The first mounting block 834 is mounted on the first fine-adjustment plate 810. The first mounting block 834 is provided with a first threaded hole (not marked). The first fine-adjustment screw rod 832 is threadedly connected to the first mounting block 834 via the first threaded hole. One end of the drive block 833 is connected to the second connection plate 382, and the other end of the drive block 833 extends at least to meet the central axis of the first fine-adjustment screw rod 832. In this manner, as the first fine-adjustment screw rod 832 is gradually screwed and the first fine-adjustment screw rod 832 pushes to move the other end of the drive block 833, one end of the drive block 833 will drive the adjustment mechanism 380 to rotate in a first pre-set direction about the central axis of the rotational bearing 831. When the first fine-adjustment screw rod 832 is screwed in the reverse direction, the first fine-adjustment screw rod 832 moves in a direction away from the drive block 833 so that the drive block 833 has a margin of movement when the adjustment mechanism 380 is manually reset.

In some embodiments, the first fine-adjustment assembly 830 also includes a second mounting block 835 mounted to the other end of the drive block 833. The first fine-adjustment screw rod 832 is connected to the second mounting block 835 after passing through the first mounting block 834. Thus, when the first fine-adjustment screw rod 832 is screwed in the reverse direction, and the first fine-adjustment screw rod 832 gradually pushes to move the other end of the drive block 833, the first fine-adjustment screw rod 832 will drive the drive block 833 to rotate, so that the drive block 833 drives the adjustment mechanism 380 to rotate about the central axis of the rotational bearing 831 in a second pre-set direction, the first pre-set direction being opposite to the second pre-set direction. For example, the first pre-set direction is a clockwise direction, and the second pre-set direction is a counterclockwise direction.

Further, the first mounting block 834 has a first clearance with the first side plate 812 and the second mounting block 835 has a second clearance with the drive block 833, so that the first mounting block 834 is rotatable relative to the first side plate 812 and the second mounting block 835 is rotatable relative to the drive block 833. As can be appreciated, the first and second clearances provide a movement margin for rotation of the first and second mounting blocks 834 and 835, respectively, to prevent the drive block 833 from being jamed when the first fine-adjustment screw rod 832 is used to adjust the position of the adjustment mechanism 380 relative to the first fine-adjustment plate 810.

Specifically, the first side plate 812 is provided with two first protruding blocks 8121. The first protruding blocks 8121 are provided with first limit holes (not marked). Two opposite ends of the first mounting block 834 are both provided with first extension blocks (not marked), and one of the first extension blocks is correspondingly inserted into one of the first limit holes so as to realize that the first mounting block 834 is mounted on the first side plate 812. Likewise, the other end of the drive block 833 is provided with two second protruding blocks 8331. Each of the second protruding blocks 8331 is provided with a second limit hole (not marked). Two opposite ends of the second mounting block 835 are both provided with a second extension block (not marked), and one of the second extension blocks is inserted into one of the second limit holes, so that the second mounting block 835 may rotate relative to the drive block 833.

In some embodiments, the first fine-adjustment assembly 830 further includes a bearing seat 836 mounted to the second mounting block 835 and a bearing member 837 embedded in the bearing seat 836. The bearing member 837 is sleeved on the first fine-adjustment screw rod 832.

In actual use, by screwing the first fine-adjustment screw rod 832, and under the action of the rotational bearing 831, the drive block 833 may be driven to move close to one end of the first fine-adjustment screw rod 832, and the other end of the drive block 833 will drive the second connection plate 382 to rotate around the central axis of the rotational bearing 831, thereby adjusting the position of the second connection plate 382 relative to the first fine-adjustment plate 810, which is convenient and fast.

In some embodiments, the fine-adjustment mechanism 800 further includes a second fine-adjustment assembly 840 mounted to the first fine-adjustment plate 810 and the second fine-adjustment plate 820. The second fine-adjustment assembly 840 is used for adjusting an angle between the first fine-adjustment plate 810 and the second fine-adjustment plate 820.

The second fine-adjustment assembly 840 includes a power lever 841 rotatably mounted to the first fine-adjustment plate 810, a first connection block 842 connected to the power lever 841, a second connection block 843 connected at one end to the first connection block 842, a connection rod 844 connected at the other end to the second connection block 843, and a hinge 845. The second connection block 843 is connected to the second fine-adjustment plate 820. Here, the surface of the power lever 841 is threaded. The first connection block 842 is provided with an internal threaded hole (not shown) with an internal thread. The power lever 841 is threadedly connected to the first connection block 842. When the power lever 841 is rotated in situ relative to the first fine-adjustment plate 810, the first connection block 842 may be driven along the axial direction of the power lever 841 under the action of the surface threads of the power lever 841 to cause the connection rod 844 to oscillate, thereby allowing the first fine-adjustment plate 810 to unfold or close relative to the second fine-adjustment plate 820. In this embodiment, the hinge 845 is located between the first fine-adjustment plate 810 and the second fine-adjustment plate 820, and the hinge 845 is located away from the first fine-adjustment screw rod 832 and adjacent to the transition slope 8223. If the first slope 8221 is gradually gentle in a direction away from the ground surface and the second slope 8222 is gradually gentle in a direction close to the ground surface along the central axis of the column module 200.

It should be appreciated that the mounting of the power lever 841 may be accomplished by providing a threaded block-like structure on the first fine-adjustment plate 810. Of course, the mounting of the power lever 841 may be accomplished in other ways, for example, the power lever 841 may be threadedly connected to the first protruding portion 8152 and the second protruding portion 8153 directly, where both the first protruding portion 8152 and the second protruding portion 8153 are provided with threaded holes (not shown), and the power lever 841 partially extends out of the first fine-adjustment plate 810 for direct screwing by a user.

In some other embodiments, the second fine-adjustment assembly 840 further includes a second fine-adjustment screw rod 845, a first bevel gear 846, a second bevel gear 847 and a limit bearing 848. One end of the second fine-adjustment screw rod 845 is connected to the first bevel gear 846, and the other end of the second fine-adjustment screw rod 845 passes out of the first fine-adjustment plate 810 and is exposed to the outside. The second bevel gear 847 is mounted on one end of the power lever 841. The second bevel gear 847 meshes with the first bevel gear 846. The other end of the power lever 841 is sleeved with the limit bearing 848. The limit bearing 848 is fixedly mounted on the second protruding portion 8153.

Thus, when the first bevel gear 846 is rotated by screwing the second fine-adjustment screw rod 845, under the action of the limit bearing 848, the second bevel gear 847 drives the power lever 841 to rotate at the original installation position, and the first connection block 842 rotates along the axial direction of the power lever 841, so as to drive the connection rod 844 to push the first fine-adjustment plate 810 to rotate relative to the second fine-adjustment plate 820, thereby adjusting the angle between the first fine-adjustment plate 810 and the second fine-adjustment plate 820. Here, it should be noted that, with the center line of the first fine-adjustment plate 810 being O1 and the center line of the second fine-adjustment plate 820 being O2, as shown in FIG. 46, the angle between the first fine-adjustment plate 810 and the second fine-adjustment plate 820 refers to the angle between O1 and O2, and screwing the second fine-adjustment screw rod 845 may adjust the angle between O1 and O2 so as to adjust the mutual position between the first fine-adjustment plate 810 and the second fine-adjustment plate 820. In this embodiment, the second fine-adjustment screw rod 845 may adjust the angle between the first fine-adjustment plate 810 and the second fine-adjustment plate 820 to be (0 degree, 3 degrees).

In some embodiments, the second fine-adjustment assembly 840 further includes a guide slipper 849 mounted to the mounting bar body 8151 and a guide bar 8410 slidably mounted to the guide bar 8410. The guide slipper 849 is connected to the first connection block 842. When the first connection block 842 is moved by the power lever 841, the first connection block 842 stably slide in the axial direction of the power lever 841 by the combined action of the guide bar 8410 and the guide slipper 849.

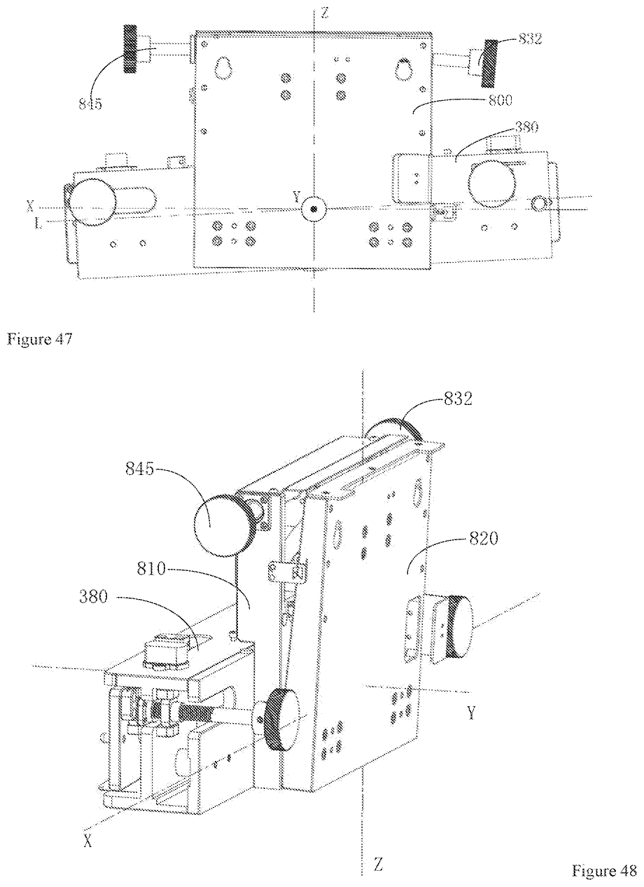

Referring to FIGS. 47-48, to facilitate the reader's understanding of the adjustment mechanism adjusting the pitch and roll angles of the crossbeam 31 relative to the column module 200, the first axis is an X-axis in FIG. 47 or 48, the second axis is the Y-axis in the drawings, and the vertical direction is a Z-axis shown in the drawings. When the user screws the first fine-adjustment screw rod 832, the whole of the adjustment mechanism 380 will rotate along the Y-axis on a first plane, the first plane being a plane formed by the intersection of the X-axis and the Z-axis, so as to adjust the roll angle of the crossbeam 31 relative to the column module 200. When the second fine-adjustment screw rod 845 is screwed, the first fine-adjustment plate 810 will rotate about the X-axis in a second plane, which is a plane formed by the intersection of the Y-axis and the Z-axis, to effect slight unfolding or closing of the first fine-adjustment plate 810 relative to the second fine-adjustment plate 820, thereby effecting adjustment of the pitch angle of the crossbeam 31 relative to the column module 200. By screwing the first drive rod 3842, it is possible to adjust the rotation angle of the crossbeam relative to the column module, which is the rotation angle of the crossbeam 31 in the plane formed by the intersection of the X-axis and the Y-axis.

The axis line L shown in FIG. 47 is the central axis direction of the crossbeam 31 after adjusting the roll angle under the action of the fine-adjustment mechanism 800. At this time, the angle between the axis line L and the X-axis is the adjusted roll angle. In the present embodiment, the first axis is the central axis of the rotational shaft of the hinge 845. The second axis is the central axis of the rotational bearing 831. The vertical direction is the axis of the column module perpendicular to the base module 100′.

By providing the fine-adjustment mechanism 800, it can be convenient for a user to screw the first fine-adjustment screw rod 832 and/or the second fine-adjustment screw rod 845 to adjust the position of the adjustment mechanism 380 relative to the column module 200, thereby adjusting the position of the crossbeam 31, which is quick and convenient for operation.

A vehicle measurement apparatus 900′ provided by an embodiment of the present invention includes a base module, a column module, and a crossbeam module. The column module is mounted on the base module 100. The crossbeam module 300 includes a crossbeam 310, an adjustment mechanism 380 and a fine-adjustment mechanism 800. One end of the fine-adjustment mechanism 800 is mounted on the column module 200, and the other end of the fine-adjustment mechanism 800 is mounted on the adjustment mechanism 380. The crossbeam 310 is mounted on the adjustment mechanism 380. The adjustment mechanism 380 is configured to adjust the position of the crossbeam 310 relative to the column module 200. The fine-adjustment mechanism 800 is configured to adjust the position of the adjustment mechanism 380 relative to the column module 200. With the above-mentioned structure, the user only needs to adjust the position of the crossbeam 31 by means of the fine-adjustment mechanism 800 and the adjustment mechanism 380 during the adjustment, so that the position of the crossbeam can be adjusted without frequently bending the base module, which is convenient to operate.

The above description is only the embodiments of the invention and do not limit the patent scope of the invention. Any equivalent structure or equivalent process transformation made using the content of the description and drawings of the invention, or the embodiments directly or indirectly applied in related technical fields, are also included in the scope of patent protection of the invention.

1. A vehicle measurement apparatus, comprising:
a base module;
a column module disposed in a vertical direction and mounted on the base module;
a crossbeam module comprising a crossbeam and an adjustment unit, wherein the crossbeam is mounted on one side of the adjustment unit; the other side of the adjustment unit is mounted to the column module; the adjustment unit is configured for adjusting a pitch angle and a roll angle formed by displacement of the crossbeam relative to the column module, wherein the pitch angle is an angle at which the crossbeam rotates about a first axis in a horizontal direction, and the roll angle is an angle at which the crossbeam rotates about a second axis perpendicular to the first axis and the vertical direction.

2. The vehicle measurement apparatus according to claim 1, wherein the adjustment unit comprises an adjustment mechanism and a fine-adjustment mechanism; wherein one end of the fine-adjustment mechanism is mounted to the column module, and the other end of the fine-adjustment mechanism is mounted to the adjustment mechanism; the crossbeam is mounted to the adjustment mechanism configured for adjusting a position of the crossbeam relative to the column module; and the fine-adjustment mechanism is configured for adjusting a pitch angle and a roll angle between the crossbeam and the column module.

3. The vehicle measurement apparatus according to claim 2, wherein the fine-adjustment mechanism comprises a first fine-adjustment plate, a second fine-adjustment plate, and a first fine-adjustment assembly; wherein one end of the first fine-adjustment plate is rotatably connected to the adjustment mechanism; the other end of the first fine-adjustment plate is connected to one end of the second fine-adjustment plate; the other end of the second fine-adjustment plate is connected to the column module; and the first fine-adjustment assembly is mounted to the first fine-adjustment plate configured for rotating the adjustment mechanism relative to the first fine-adjustment plate.

4. The vehicle measurement apparatus according to claim 3, wherein the first fine-adjustment assembly comprises a rotational bearing, a first fine-adjustment screw rod, a drive block, and a first mounting block; the rotational bearing is mounted to the first fine-adjustment plate; the rotational bearing is connected to the adjustment mechanism; the first mounting block is mounted to the first fine-adjustment plate; the first mounting block is provided with a first threaded hole; the first fine-adjustment screw rod is threadedly connected to the first mounting block via the first threaded hole; one end of the drive block is connected to the adjustment mechanism, and the other end of the drive block extends at least to meet the central axis of the first fine-adjustment screw rod; and
when the first fine-adjustment screw rod is gradually screwed and the first fine-adjustment screw rod gradually pushes the other end of the drive block to move, one end of the drive block will drive the adjustment mechanism to rotate in a first pre-set direction about the first axis, the first axis being the central axis of the rotational bearing.

5. The vehicle measurement apparatus according to claim 4, wherein the first fine-adjustment assembly further comprises a second mounting block mounted to the other end of the drive block; the first fine-adjustment screw rod passes through the first mounting block and then is connected to the second mounting block; and
when the first fine-adjustment screw rod is screwed in a reverse direction and the first fine-adjustment screw rod gradually moves in a direction away from the first fine-adjustment plate, the drive block drives the adjustment mechanism to rotate about the central axis of the rotational bearing in a second pre-set direction, the first pre-set direction being opposite to the second pre-set direction.

6. The vehicle measurement apparatus according to claim 5, wherein the first mounting block is rotatable relative to the first fine-adjustment plate; the second mounting block is rotatable relative to the drive block; a first gap is provided between the first mounting block and a side wall of the first fine-adjustment plate; and a second gap is provided between the second mounting block and the drive block.

7. The vehicle measurement apparatus according to claim 5, wherein the first fine-adjustment assembly further comprises a bearing seat mounted to the second mounting block and a bearing member embedded in the bearing seat, the bearing member being sleeved on the first fine-adjustment screw rod.

8. The vehicle measurement apparatus according to claim 3, wherein the fine-adjustment mechanism further comprises a second fine-adjustment assembly mounted to the first fine-adjustment plate and the second fine-adjustment plate; and the second fine-adjustment assembly is configured for adjusting an angle between the first fine-adjustment plate and the second fine-adjustment plate.

9. The vehicle measurement apparatus according to claim 8, wherein the second fine-adjustment assembly comprises a power lever, a first connection block, a second connection block, a connection rod, and a hinge; one end of the hinge is connected to the first fine-adjustment plate, and the other end of the hinge is connected to the second fine-adjustment plate; the power lever is rotatably mounted to the first fine-adjustment plate; the first connection block is connected to the power lever; one end of the connection rod is connected to the first connection block, and the other end of the connection rod is connected to the second connection block; and the second connection block is connected to the second fine-adjustment plate, wherein the first connection block is provided with an internal threaded hole, the surface of the power lever has a thread; the first connection block is threadedly connected with the power lever; and
when the power lever rotates and drives the first connection block along the axial direction of the power lever, the connection rod swings therewith to drive the first fine-adjustment plate to unfold or close relative to the second fine-adjustment plate.

10. The vehicle measurement apparatus according to claim 9, wherein the second fine-adjustment assembly comprises a guide slipper and a guide bar; the first fine-adjustment plate comprises a mounting bar; the guide bar is mounted to the mounting bar; the guide slipper is slidably mounted to the guide bar; and the guide slipper is connected to the first connection block.

11. The vehicle measurement apparatus according to claim 9, wherein the second fine-adjustment assembly further comprises a second fine-adjustment screw rod, a first bevel gear, a second bevel gear and a limit bearing; one end of the second fine-adjustment screw rod is connected to the first bevel gear, and the other end of the second fine-adjustment screw rod is exposed outside the first fine-adjustment plate; the second bevel gear is mounted on one end of the power lever; the second bevel gear meshes with the first bevel gear; the other end of the power lever is sleeved with the limit bearing; the limit bearing is fixedly mounted on the first fine-adjustment plate; and
when the first bevel gear is rotated by screwing the second fine-adjustment screw rod, the second bevel gear drives the power lever to rotate, so as to adjust an angle between the first fine-adjustment plate and the second fine-adjustment plate.

12. The vehicle measurement apparatus according to claim 2, wherein the adjustment mechanism is configured for adjusting a rotation angle of the crossbeam relative to the column module, the rotation angle being an angle at which the crossbeam rotates about a central axis of the column module.

13. The vehicle measurement apparatus according to claim 12, wherein the adjustment mechanism comprises a first connection plate connected to the crossbeam, a second connection plate connected to the fine-adjustment mechanism, a supporting plate connected to the second connection plate and located between the first connection plate and the second connection plate, and an adjustment assembly mounted to the first connection plate, the second connection plate and the supporting plate and configured for adjusting a rotation angle between the crossbeam relative to the column module.

14. The vehicle measurement apparatus according to claim 13, wherein the adjustment assembly comprises a rotating shaft rotatably mounted to the supporting plate and connected to the first connection plate, a first drive rod, an elastic member, and a mounting rod; the first drive rod is connected to one end of the first connection plate; the first drive rod is connected to the supporting plate; the mounting rod is mounted to the other end of the first connection plate; the mounting rod faces towards the supporting plate; the elastic member is sleeved on the mounting rod; and
when the first drive rod is driven to move one end of the first connection plate in a direction away from the supporting plate, under the action of the rotating shaft, the other end of the first connection plate moves towards the supporting plate and presses the elastic member, so that the first connection plate rotates the crossbeam about the central axis of the column module.

15. The vehicle measurement apparatus according to claim 14, wherein the adjustment assembly further comprises a third mounting block rotatably mounted to the first connection plate, the first drive rod being connected to the third mounting block, wherein a third gap is provided between the third mounting block and an end face of the first connection plate facing towards the second connection plate.

16. The vehicle measurement apparatus according to claim 15, wherein the adjustment mechanism further comprises a fourth mounting block rotatably mounted to the supporting plate, the fourth mounting block being provided with an inner threaded hole; and the first drive rod is threadedly connected to the fourth mounting block.

17. The vehicle measurement apparatus according to claim 14, wherein the adjustment assembly further comprises a receiving member, one end of which has an opening; the supporting plate is provided with a communication hole; the receiving member is mounted to the supporting plate; the opening communicates with the communication hole; the elastic member is partially received in the receiving member; one end of the elastic member abuts against a bottom of the receiving member; and the other end of the elastic member abuts against the first connection plate, wherein a diameter of the communication hole is greater than an axial diameter of the mounting rod.

18. The vehicle measurement apparatus according to claim 14, wherein the adjustment assembly further comprises a second screw rod, a rack, a gear, and a sliding bar; the sliding bar is mounted to the supporting plate, and can slide in a pre-set direction relative to the supporting plate; the second connection plate is connected to the sliding bar; the rack is mounted to the supporting plate; the supporting plate is provided with an avoidance hole; the gear is mounted to one end of the second screw rod; the other end of the second screw rod passes through the avoidance hole; the gear meshes with the rack; and
when the second screw is screwed, the gear drives the rack to move the supporting plate in the pre-set direction.

19. The vehicle measurement apparatus according to claim 18, wherein the adjustment assembly further comprises a guide slipper mounted to the supporting plate, the guide slipper being mounted in cooperation with the sliding bar.

20. The vehicle measurement apparatus according to claim 14, wherein the adjustment assembly further comprises a level bead mounted to the supporting plate and configured for detecting whether the crossbeam is in a horizontal state.

21-28. (canceled)
